(19) United States
(12) Patent Application Publication
(10) Pub. No.: US 2025/0051195 A1
(43) Pub. Date: Feb. 13, 2025

(54) METHODS AND SYSTEMS FOR REMOVING CONTAMINANTS AND NUTRIENTS FROM A FLUID

(71) Applicants: University of Vermont and State Agricultural College, Burlington, VT (US); City of Essex Junction, Essex Junction, VT (US)

(72) Inventors: Appala Raju Badireddy, Burlington, VT (US); James Jutras, Essex Junction, VT (US); Kamruzzaman Khan, Burlington, VT (US)

(21) Appl. No.: 18/721,969

(22) PCT Filed: Dec. 21, 2022
(86) PCT No.: PCT/US2022/082118

§ 371 Date: Jun. 20, 2024

Related U.S. Application Data
(60) Provisional application No. 63/293,899, filed on Dec. 27, 2021.

(51) Int. Cl. C02F 1/469; C02F 1/467; C02F 1/48; C02F 101/10; C02F 101/36

(52) U.S. Cl. CPC C02F 1/4693; C02F 1/4672; C02F 1/484; C02F 2101/105; C02F 2101/36; C02F 2201/46115; C02F 2201/46125; C02F 2201/48; C02F 2303/04

(57) ABSTRACT

A method of removing charged contaminants from a fluid is provided. The method may include providing a filtration membrane in a fluid passageway, flowing a fluid through the fluid passageway and through the filtration membrane, and generating an electromagnetic field within the passageway at a location upstream from the filtration membrane to pretreat the fluid prior to the filtration membrane to enable the charged contaminants to precipitate out of solution. The method may further include generating an electric field across the filtration membrane at an amount effective to separate and degrade the charged contaminants on a first side of the filtration membrane. Methods of removing charged nutrients from a fluid are also provided.

### RELATED APPLICATIONS

The present application claims the benefit under 35 U.S.C. § 119 (e) to U.S. Provisional Application No. 63/293,899 filed on Dec. 27, 2021, the contents of which is incorporated by reference herein in its entirety.

### FIELD OF THE INVENTION

The disclosure relates, in part, to methods and systems for separating and removing charged compositions out of a fluid, such as water.

### BACKGROUND

In a filtration system, such as a water treatment system, it may be desirable to remove one or more compositions from the water stream. For example, phosphorous-containing compositions may be present in water treatment systems. One example of a phosphorous-containing composition is struvite (magnesium ammonium phosphate hexahydrate or MgNH₄PO₄·6H₂O). Struvite is a crystalline compound formed when magnesium ammonium phosphate ions are dissolved in a waste stream's liquid water phase above saturation concentrations. These compositions can build up on the surfaces clogging pipes, fouling valves and otherwise creating severe maintenance problems. Another example includes the recalcitrant contaminants such as per- and polyfluoroalkyl susbtances (PFAS) which do not typically degraded by the conventional treatment processes. These compositions could cause significant pose to environmental and human health.

### SUMMARY

One aspect of the present disclosure is directed to a method of removing charged dissolved and particulate contaminants from a fluid. The method may include providing a filtration membrane in a fluid passageway, flowing a fluid through the fluid passageway and through the filtration membrane, and generating an electromagnetic field within the passageway at a location upstream from the filtration membrane to pretreat the fluid prior to the filtration membrane to enable the charged contaminants to precipitate out of solution or be destroyed in solution. The method may further include generating an electric field across the filtration membrane at an amount effective to separate and degrade the charged contaminants on a first side (i.e., feed side) of the filtration membrane.

Another aspect of the present disclosure is directed to a method of removing charged nutrients from a fluid. The method may include providing a filtration membrane in a fluid passageway, flowing a fluid through the fluid passageway and through the filtration membrane, and generating an electromagnetic field within the passageway at a location upstream from the filtration membrane to pretreat the fluid prior to the filtration membrane to enable the charged nutrients to precipitate out of solution. The method may further include generating an oscillating electric field across the filtration membrane at an amount effective to separate the charged nutrients on a first side of the filtration membrane, where the relative supersaturation of the fluid is at least 1.

### BRIEF DESCRIPTION OF THE DRAWINGS

FIG. 1 is a schematic illustration of one embodiment of an oscillating field-enhanced membrane filter;

FIG. 2 is a schematic illustration of one embodiment of a system configured to be deployed to a wastewater system;

FIG. 3 is an illustration of one embodiment of a water treatment system including an electromagnetic field (EMF) device and a filtration membrane;

FIG. 4 is an illustration of one embodiment of a filtration membrane utilizing an oscillatory electric field;

FIG. 5 is an illustration of one embodiment of a filtration membrane utilizing electro-oxidation separation;

FIG. 6 is one illustration of one embodiment of a filtration membrane utilizing electro-sorption-oxidation removal with a modified conductive filter;

FIG. 7 is one illustration of one embodiment of a filtration membrane with a first electric field generated across the conductive membrane;

FIG. 8 is one illustration of one embodiment of a filtration membrane with a second electric field generated across the conductive membrane;

FIG. 9 is another illustration of the conductive filtration membrane shown in FIG. 6;

FIG. 10 is an illustration of the filtration membrane with the polarity of the two electrodes reversed to clean the conductive membrane;

FIG. 11 is an illustration of one embodiment of a water treatment system;

FIG. 12 is a schematic which illustrates one embodiment of an experimental setup;

FIG. 13 is a schematic which illustrates one type of EMF device which may be used in the water treatment system obtained from HydroFlow;

FIG. 14 is a schematic which illustrates typical side-stream wastewater composition of the sampling site according to one particular embodiment, however, this approach may be applied to any high-strength water and wastewater;

FIG. 15 illustrates the effects of the oscillating electric field on the solution pH;

FIG. 16 illustrates the effects of the oscillating electric field on the solution temperature;

FIGS. 17A and 17B illustrate the effects of the oscillating electric field on induction time;

FIG. 18 illustrates the effects of the oscillating electric field on solids recovery;

FIG. 19 illustrates the effects of the oscillating electric field on struvite morphology;

FIG. 20 illustrates a schematic of one embodiment of the proposed mechanism used to form struvite with an oscillating electric field;

FIG. 21 illustrates wastewater composition results according to one embodiment;

FIG. 22 illustrates crystal nucleation time sample with and without exposure to the EMF device;

FIG. 23 illustrates the crystallization mechanism for samples in a control group without exposure to the EMF device;

FIG. 24 illustrates the crystallization mechanism for samples exposed to the EMF device according to one embodiment;

FIG. 25 illustrates the temperature comparison between a control group of samples without exposure to the EMF device and a group of samples exposed to the EMF device according to one embodiment;

FIG. 26 illustrates the pH comparison between a control group of samples without exposure to the EMF device and a group of samples exposed to the EMF device according to one embodiment;

FIG. 27 illustrates the bench-scale electrofiltration system in the presence and absence of a range electric field strengths at a constant frequency of 1000 Hz according to one embodiment;

FIG. 28 illustrates the normalized flux over time for a control sample and a sample treated with an EMF device according to one embodiment;

FIG. 29A-29F illustrates the effects of electric field strength on filtration flux in an electrofiltration system according to one embodiment;

FIG. 30A illustrates the pilot filtration flux data in the presence and absence of an electric field according to one embodiment; and

FIG. 30B illustrates a comparison between various different flux data in the presence and absence of an electric field according to one embodiment.

### DETAILED DESCRIPTION

This disclosure builds upon Applicant's earlier disclosure in U.S. application Ser. No. 17/272,782 filed on Mar. 2, 2021, the contents of which is incorporated by reference in its entirety.

Aspects of the present disclosure are directed to methods and systems for removing charged contaminants from a fluid, such as a water source, wastewater or waste slurries. As set forth below, the disclosure sets forth methods for both separating and also degrading the contaminants to remove the contaminants from the fluid. In one particular embodiment, the contaminants may include various heavy metal ions, microorganisms, viruses, per- and polyfluoroalkyl substances (PFAS), emerging contaminants, and/or Escherichia coli. It should be appreciated that in this disclosure, contaminants are any compositions that are harmful and/or not desirable in the fluid stream.

Further aspects of the present disclosure are directed to methods of removing charged nutrients (nitrogen and phosphorus) from a fluid, such as a water source, wastewater or waste slurries. As set forth below, the disclosure sets forth methods for separating these charged nutrients so that these nutrients can be recovered from the fluid. In one particular embodiment, the nutrients may include phosphorous and/or nitrogen. It should be appreciated that in this disclosure, nutrients are any compositions that can be harvested from the fluid stream and have a future use. In one embodiment, methods and systems are provided for removing any phosphorous from any phosphorous-rich water, wastewater, including but not limited to waste slurries, dairy wastewater (i.e. washwater), and other fluid and solid waste/manure applications. In one embodiment, methods and systems are provided for removing any nutrient from a fluid that is rich in that particular nutrient.

Aspects of this disclosure are directed to an integrated electrohydrodynamic and microfiltration system to rapidly remove and recover phosphorous from sidestream water. The system may also be used to remove per- and polyfluoroalkyl substances (PFAS) from wastewater. In one embodiment, this system uses (1) decaying oscillating electric fields, (2) hydrodynamics, and (3) microfiltration to recover phosphorous over 85% within 15 minutes of treatment. Electrohydrodynamic treatment of sidestream water may rapidly convert dissolved phosphorous into struvite fine particulates, which are then recovered via gravity settling and membrane filtration. The success of the process depends on the fine tuning of the electrohydrodynamic parameters including electric field frequency, field strength, Reynolds number, and seed ion concentration such as magnesium. In one embodiment, the system removes phosphorous from the digested sludge, thus reducing sludge production, reducing the chemicals needed for nitrogen and phosphorous treatment, and improving the process reliability for maintaining effluent phosphorous concentrations below regulatory limits in the conventional wastewater treatment process (i.e., 0.2 mg/L total phosphorous in Vermont Lake Champlain basin).

Further aspects of the present disclosure are directed to a portable unit which is configured to be deployed to location, such as a wastewater system, to separate charged compositions (contaminants and nutrients) from the wastewater system. As set forth in more detail below, the portable unit may be sized to fit on a towable trailer.

It should be appreciated that although the disclosure focuses on the removal of a contaminant, such as PFAS, from a fluid, and nutrients, such as phosphorous and nitrogen, from a fluid, that it is also contemplated that the technology could be used to remove other compositions, such as, but not limited to various microbes, dissolved minerals, heavy metals, rare earth metals, organic molecules, pathogens, bacteria, and viruses. As set forth in more detail below, in one embodiment, the disclosure is directed to methods for removing a contaminant such as Escherichia coli (E. coli).

Aspects of the present disclosure are directed to a water/fluid treatment system with electromagnetic field-treated feed water. For example, as set forth in more detail below, the water treatment system may include a fluid passageway and an electromagnetic field (EMF) device coupled to the passageway and configured to selectively generate an electric field within the passageway. The EMF device may alter one or more properties of compositions in the feed water, which may assist in the removal of these compositions (i.e. contaminants and nutrients) from the water. In one embodiment, the electromagnetic field is configured to alter a charged contaminant or nutrient. Pipe Descaling Technology (PDT) which uses an induced electric field of variable amplitude and frequency is used to promote the precipitation of crystalline minerals (such as struvite). As set forth in greater detail below, in one embodiment, the EMF device may alter the shape of one or more of the compositions. For example, struvite precipitates may have a needle-like shape without the EMF device, but with the electromagnetic field, have a sphere-like shape. Experimentation has shown that the EMF device may cause molecular-level alterations that may occur in the feed water during the course of the exposure to the EMF. It is contemplated that the electromagnetic field may cause accelerated crystal growth and purity, which may result in one or more of: (1) a reduction in the concentration of ions in the feed water, (2) a change in a size of one or more of the particles, and (3) a change in the shape of one or more particles, thus the particles can be more easily captured and removed from the EMF-treated feed water. Particles may be defined as one or more compositions. For example, in one embodiment, a particle may be a cluster of the compositions. It is also contemplated that the electromagnetic field may alter the fundamental nature of the crystalline clusters making them softer, non-sticky, and easier to wash off from various surfaces.

Further aspects of the present disclosure are directed to a water treatment system with an electrically activated conductive membrane. For example, as set forth in more detail below, the water treatment system may include a filtration membrane, and a first electrode and a second electrode. The electrodes may be configured to provide an oscillating-field across the membrane. The electrically activated conductive membrane may help to prevent one or more charged compositions (i.e., contaminants and nutrients) from depositing and forming scale on the membrane surfaces. In one embodiment, such a membrane may be configured in a dead-end filtration system. In another embodiment, such a membrane may be configured in a crossflow filtration system.

It is contemplated that in a crossflow filtration system with an electrically activated conductive membrane, the oscillating particles (various charged compositions) may then be carried away by the cross flow, and thus removed from the feed water. This technique may be used to concentrate and recover various charged compositions, such as various contaminants and/or nutrients from water streams and it may also keep the membrane surface free of scale for a significant period of time. In some embodiments, concentrated compositions may be recovered by various means and used in other applications.

As set forth in further detail below, in one embodiment, the electrically activated conductive membrane may be configured as an electric filtration cell configured to capture various compositions. In one embodiment, the electric filtration cell may be a custom-designed filtration cell that can be retrofitted into an existing water treatment system. In one embodiment, the electric filtration cell may be configured to be portable and it may be configured to be easily removed from the system as desired. This electric filtration cell may include the above described filtration membrane and electrode assembly and it may be retrofitted to existing waste water systems.

The electric filtration cell may utilize an oscillating electric-field assisted membrane filtration to recover various compositions from a wastewater stream. This may be termed an OEF Membrane (Oscillating Electric Field on or across Membrane). In one embodiment, the oscillating field may be provided with an Alternating-Current (AC) power source. In one embodiment, a continuous field alternating current may be provided. In another embodiment, a pulsed field alternating current may be provided. It is contemplated that an oscillating electric field may be advantageous over a Direct Current (DC) electric field for preventing the compositions from sticking to and/or becoming embedded within the filtration membrane.

It should be recognized that in one embodiment, the water treatment system may include both an electromagnetic field (EMF) device and an electrically activated conductive membrane. In another embodiment, the water treatment system may include an electromagnetic field (EMF) device, without an electrically activated conductive membrane. In yet another embodiment, the water treatment system may include an electrically activated conductive membrane, without an electromagnetic field (EMF) device. In another embodiment, the water treatment system may include two or more electromagnetic field (EMF) devices placed at locations to synchronize the EMF signal to intensity the EMF effect.

In water treatment system embodiments that include one or more filtration membranes, it is contemplated that the filtration membranes may be one or more of a microfiltration membrane, an ultrafiltration membrane, a nanofiltration membrane, forward osmosis, and a reverse osmosis membrane. In one embodiment, the microfiltration membrane is configured to filter out particles that are larger than 0.1 μm, the ultrafiltration membrane is configured to filter out particles that are larger than 0.01 μm, the nanofiltration membrane is configured to filter out particles that are larger than 0.001 μm, and the reverse osmosis membrane is configured to filter out dissolved substances and particles that are larger than 0.0001 μm. It is contemplated that in one embodiment, a plurality of filtration membranes may be employed where different compositions may be recovered on different membranes based upon the characteristics and size of the membranes.

As set forth in more detail below, in one embodiment, a water treatment system includes one or more filtration membranes positioned between a first electrode and a second electrode. The first and second electrodes act as a cathode and an anode and can be activated with a low-frequency alternating current (AC) to provide an oscillating field across the membrane. In one embodiment, the filtration membrane may include an ultrafiltration membrane (UF) and a reverse osmosis (RO) membrane, although one of ordinary skill in the art will appreciate that other types and combinations of membranes are also contemplated.

In one embodiment, the first electrode is integrally formed with the filtration membrane. For example, the electrical activation of the filtration membranes may be achieved by membrane material modification with carboxyl-functionalized multi-walled carbon nanotubes (MWCNTs), graphene, or any conductive polymers and metals. MWCNT's have extraordinary electrical conductivity and mechanical strength, and thus can be used as both electrodes and membrane elements. In an embodiment of a cross flow filtration system, the discharge from the system is configured to flow tangentially on the membrane. In one embodiment, the anode (i.e. second electrode) is a graphite paper or conductive fabric (or plate, sheet), the cathode (i.e. first electrode) is the MWCNT/UF membrane and/or MWCNT/RO membrane mounted parallel to the flow path, and the membrane is supported by a porous polycarbonate structure. In some embodiments, the porous polycarbonate structure has a honeycomb configured structure.

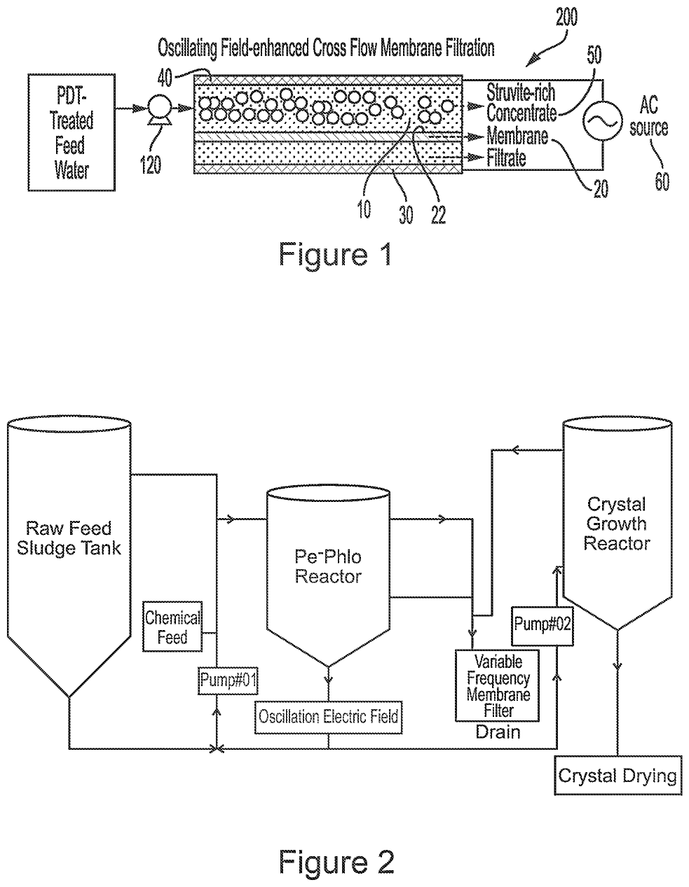

Turning to FIG. 1, in one embodiment, an electric filtration cell 200 is provided for use in a water treatment system where the electric filtration cell is configured to separate charged compositions from a fluid, such as a water stream. As shown in FIG. 1, the electric filtration cell 200 may include a fluid passageway 10 configured for the water stream to flow there through. The electric filtration cell 200 may also include a filtration membrane 20 positioned within the passageway 10, and a first electrode 30 and a second electrode 40, where the first and second electrodes 30, 40 are configured to selectively provide an oscillating electric field across the filtration membrane 20 to separate charged compositions 50 on a first side 22 of the filtration membrane. In one embodiment, the charged compositions 50 may be struvite-rich retentate. In one embodiment, the phosphorous-containing composition includes struvite (magnesium ammonium phosphate hexahydrate or MgNH₄PO₄·6H₂O). In one embodiment, the phosphorous-containing composition includes vivianite (Fe₃(PO₄)₂·8H₂O).

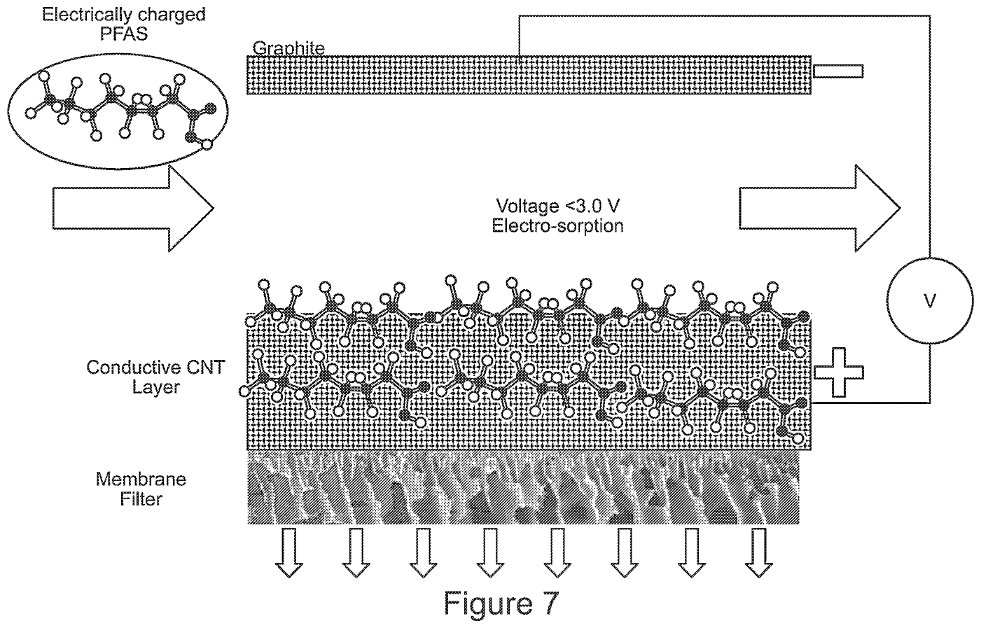

As shown in FIG. 1, in one illustrative embodiment, the first electrode 30 and the filtration membrane 20 are separately formed components. For example, as shown in FIG. 6, the filtration membrane 20 is positioned between the first electrode 30 and the second electrode 40.

As discussed in more detail below, in another embodiment, the first electrode 30 is integrally formed with the filtration membrane 20. As mentioned above, the first electrode and the filtration membrane may be formed of carbon nanotubes. In one particular embodiment, the first electrode and the filtration membrane are formed of carboxyl-functionalized multi-walled carbon nanotubes (MWCNT) and the second electrode 40 is formed of graphite paper. The filtration membrane 20 may also include a framework, such as a porous polycarbonate structure for additional support. It is also contemplated that these components may be configured differently within the water treatment system, as the disclosure is not limited in this respect.

As shown in FIG. 1, the electric filtration cell 200 may include an Alternating-Current (AC) power source 60 configured to selectively provide an oscillating electric field across the filtration membrane 20. As set forth in more detail below, experimentation has shown that an oscillating electric field may be desirable to assist in the removal of the collected composition 50 (contaminant or nutrient) from the first side 22 of the membrane 20. In particular, in contrast to a direct current electric field, the oscillating electric field may prevent the charged composition 50 from becoming embedded within the membrane 20. Thus, the charged composition 50 may be more easily removed and/or flushed from the membrane 20.

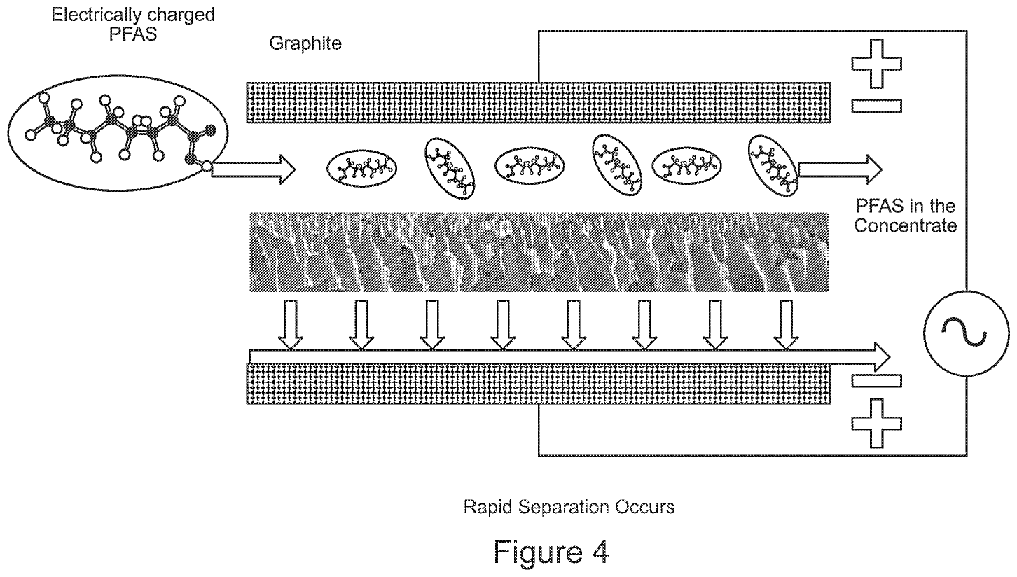

As shown in FIG. 1, a water treatment system may be provided to separate charged compositions (contaminants and/or nutrients) from a water stream, where the water treatment system includes a fluid passageway 10 configured for the water stream to flow there through, and an electromagnetic field (EMF) device coupled to the passageway 10 and configured to selectively generate an electromagnetic field within the passageway. As shown in FIG. 3, in one embodiment, the EMF device may be obtained from HYDROFLOW® USA of Redmond, WA. As shown, the system may also include a filtration membrane 20, and a first electrode 30 and a second electrode 40 configured to selectively provide an oscillating electric field across the filtration membrane to separate charged compositions on a first side 22 of the filtration membrane 20. As mentioned above, in one embodiment, the filtration membrane 20, the first electrode 30 and the second electrode 40 may be configured as an electric filtration cell 200. It is also contemplated that these components may be configured differently within the water treatment system, as the disclosure is not limited in this respect. The system may also include one or more pumps 120 (see FIG. 1) configured to flow water through the passageway 10.

As set forth in more detail below, in one embodiment, the filtration membrane 20 is configured to separate struvite and/or vivianite from a water stream. In one embodiment, the filtration membrane 20 is configured to separate nutrients, such as phosphorous or nitrogen, from a water stream. In yet another embodiment, it is also contemplated that the filtration membrane 20 is configured to separate and degrade contaminants, such as PFAS from a water stream.

One of ordinary skill in the art will recognize that the following materials may be used to form the electrodes, including but not limited to carbon nanotubes, graphene, carbon paper, graphite, titanium, stainless steel, carbon nanotube- and graphene-based membrane composites. One of ordinary skill in the art will also recognize that the following materials may also be used to form the filtration membrane, including, but not limited to carbon nanotubes, graphene, ceramic, nanocellulose, membrane polymers embedded with electrically conductive elements.

A pipe descaling technology (PDT) may be used for phosphorus removal in multiple sizes of wastewater applications. The technology uses an induced electric field of variable amplitude and frequency that can promote precipitation of crystalline minerals (struvite) without the dangerous and damaging adhesion to pipes, pumps or in tanks. The PDT coupled with the electric filtration cell may be employed to enhance nutrient capture.

Struvite (magnesium ammonium phosphate hexahydrate or MgNH₄PO₄·6H₂O) is a crystalline compound formed when magnesium ammonium phosphate ions are dissolved in a waste stream's liquid water phase above saturation concentrations. Struvite generation can also be employed to remove phosphorus from waste streams. This disclosure, in part, comprises the novel application of pipeline descaling technology (PDT) as a means of enhancing struvite generation and phosphorus removal in a cost-effective manner. Additionally, this disclosure, in part includes, innovative oscillating electric-field assisted membrane filtration means and technology useful to capture and recover compositions from the water stream exposed to PDT. Enhanced struvite generation and capture would improve the scalability of water resource recovery facilities.

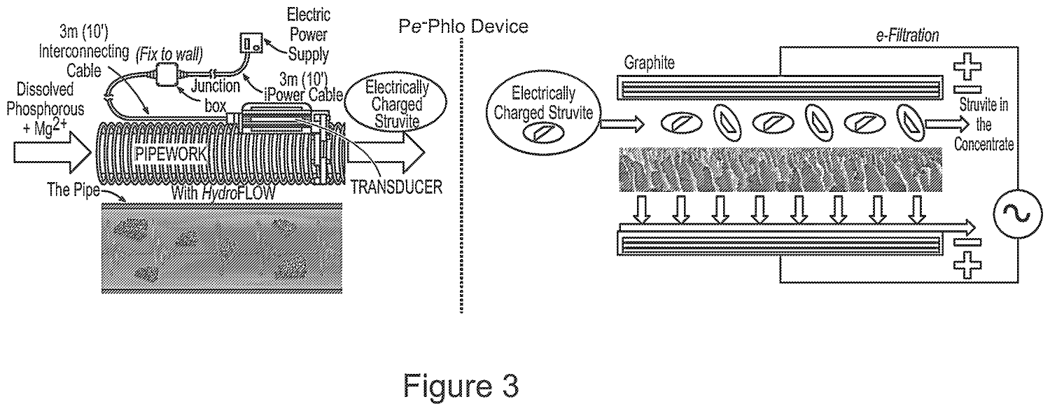

FIG. 2 is an illustration of one embodiment of a system configured to be deployed to a wastewater system and includes a schematic of a continuous reactor design. At the center of FIG. 2 is the reactor, and the above-described oscillating electric field and filtration membrane. On the left is the raw feed sludge tank which may hold the fluid before it passes through the membrane. On the right is a crystal grow reactor and crystal drying locations. It should be recognized that after the struvite is collected on the membrane, the struvite goes into the crystal grow reactor. It should be recognized that the system includes a plurality of pumps, fluid passageways, and valves to control the flow of the fluid through the system. Furthermore, as shown, there is a drain coupled to the membrane, so that after fluid passes through the membrane, it exits the system through the drain.

In one embodiment, the system shown in FIG. 2 is a portable unit which is configured to be deployed to a wastewater system to separate charged contaminants and/or nutrients from a wastewater system. In one embodiment, the portable unit is sized to fit on a towable trailer and is configured to selectively be coupled to a wastewater system. In one embodiment, there is a mobile/portable unit that could be designed to be shared by multiple facilities and it could be moved from facility to facility on an as needed basis. In another embodiment, the unit may be a permanent installation at wastewater system, such as, but not limited to a wastewater facility, dairy farm or other type of farm, landfill site, or solid waste management facility. The unit may be automated, user friendly and compact in floor plan. In one embodiment, the unit may fit on a tow behind trailer. In one embodiment, a second reactor tank may be employed. These tanks may be positioned inside of the trailer, and/or one or more tanks/reactors may be positioned outside of the trailer depending upon the filter testing results.

Turning now to FIGS. 3-11, methods and systems for removing contaminants will now be described. In one particular embodiment, the contaminants may include per- and polyfluoroalkyl substances (PFAS). FIG. 3 is an illustration of one embodiment of a water treatment system including an electromagnetic field (EMF) device and a filtration membrane. As shown, in one embodiment, the EMF device is obtained from HydroFlow, and it is used to create electrically charged struvite. The electrically charged struvite then flows through the above-described electric filtration cell to concentrate struvite on the membrane. Building upon the technology developments discussed in Applicant's earlier patent applications, the inventors recognized a need to utilize this technology to degrade and/or destroy PFAS in contaminated water streams.

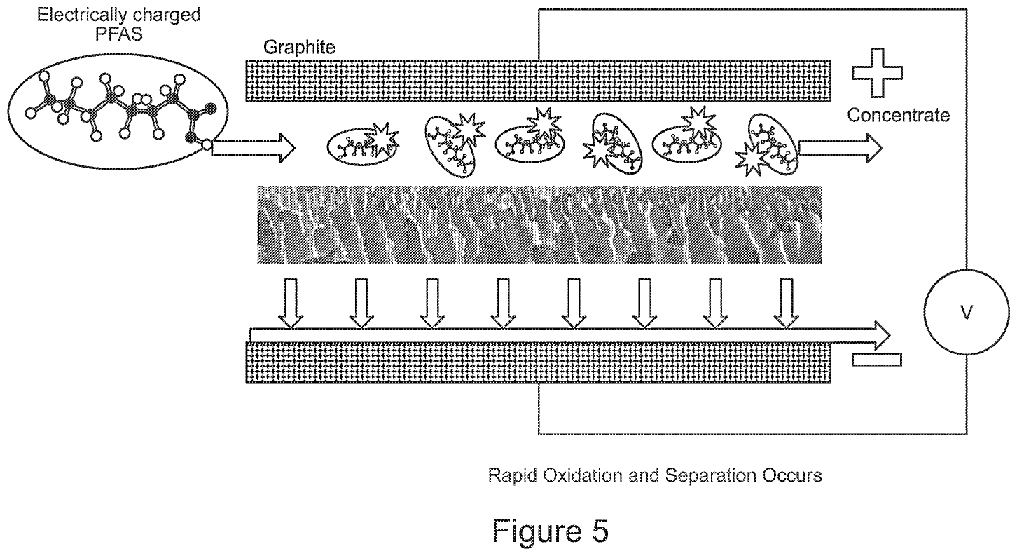

One approach to degrading PFAS in contaminated water is shown in FIG. 4, which is an illustration of one embodiment of a filtration membrane utilizing an oscillatory electric field. As shown, the electrically charged PFAS may enter the filtration cell and an oscillating electric field may be applied between the first and second electrodes. Rapid degradation and separation of the PFAS from the water may occur and the PFAS in the concentrate may collect on the surface of the membrane. In one embodiment, the first and second membranes are made of graphite, or any other conductive material.

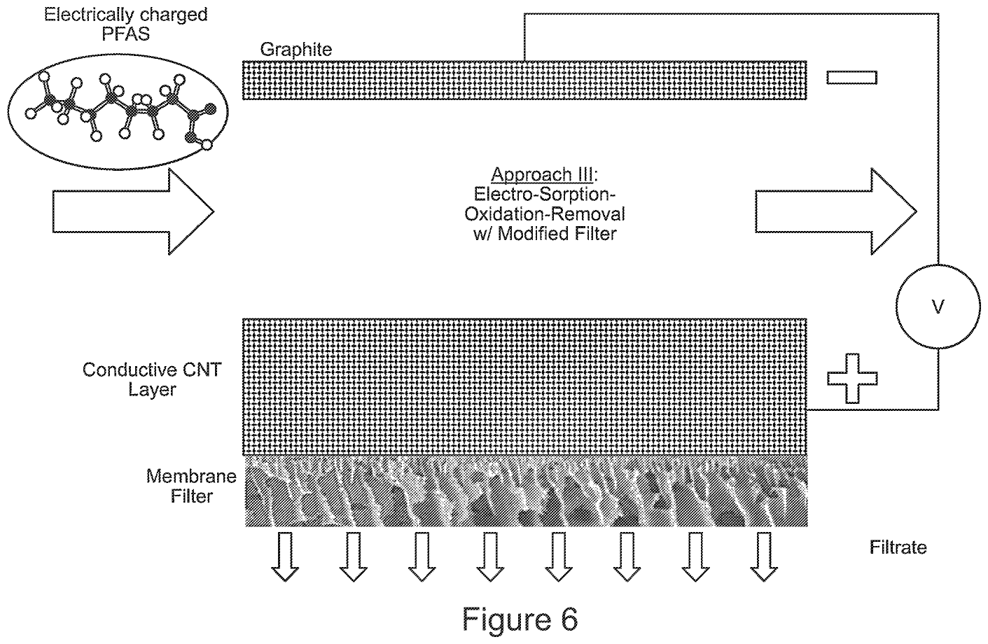

Another approach to degrading PFAS in contaminated water is shown in FIG. 5, which is an illustration of one embodiment of a filtration membrane utilizing electro-oxidation separation. One of ordinary skill in the art will appreciate that electrochemical oxidation has been used as a wastewater treatment method to remove organic contaminants for decades. During electrolysis, electron-rich organics are directly oxidized on anode surface and/or indirectly oxidized by oxidants that generated from the anode. Electrochemical oxidation is considered highly efficient for chemical oxygen demands (COD) reduction, especially for the destruction of emerging contaminants that are refractory to conventional methods

Electro-oxidation is a development along similar lines as electro-coagulation where anodic oxidation on the anode surface is employed in place of direct chemical/photochemical oxidation. An alternate variation of this process involves only the generation of an oxidizing species using the electrochemical route followed by direct oxidation by the generated oxidizing agents. Thus, the basic mechanism is the same while the location and the form of the oxidation reaction are slightly different. Similarly to the conventional oxidation process, common oxidizing agents are the hydroxyl radical, hydrogen peroxide, chlorine, and ozone. The design of the electrochemical cell, selection of electrodes, operational parameters, and cost of power are critical parameters for the application of electro-oxidation in wastewater treatment.

As shown, the electrically charged PFAS may enter the filtration cell, and rapid oxidation and separation occurs and the PFAS in the concentrate may collect on the surface of the membrane.

A third approach to degrading PFAS in contaminated water is shown in FIG. 6, which is an illustration of one embodiment of a filtration membrane utilizing electro-sorption-oxidation removal with a modified filter. One of ordinary skill in the art will appreciate that electro-sorption is a technology to remove ions from water by applying an electrical voltage difference between two porous carbon electrodes, in which ions will be temporarily stored. Electro-sorption is the result of the concomitant development of porous electrode materials and electric double layer (EDL) theory.

As shown, in this embodiment shown in FIG. 6, the membrane itself is conductive and acts as one of the electrodes. As shown, the membrane includes a membrane filter layer and a conductive carbon nanotube layer.

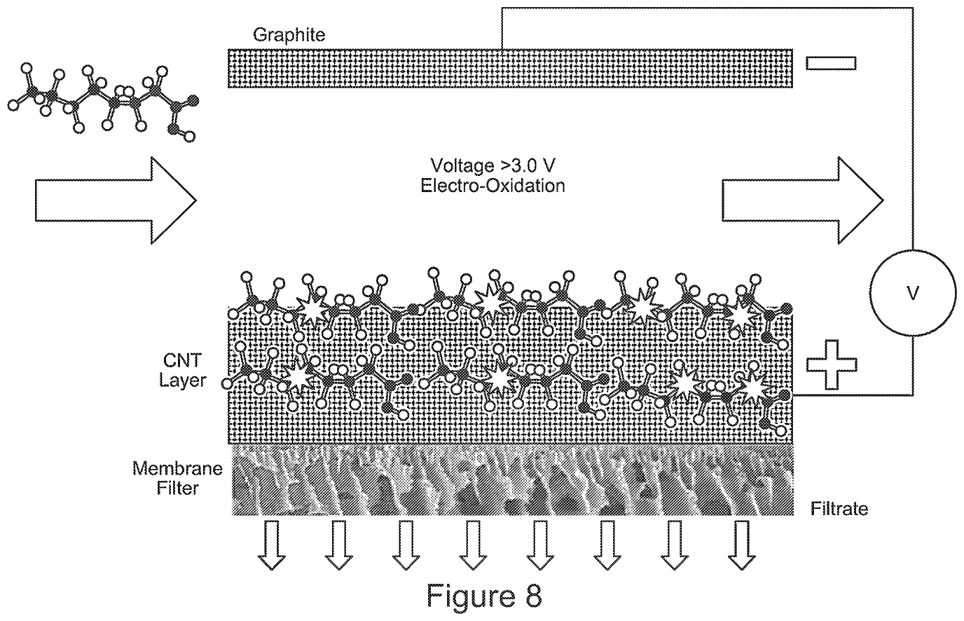

As shown in FIG. 7, in one embodiment, with any of the three above described approaches, first, a low voltage is applied across the membrane so that the contaminants (such as PFAS) stick to the membrane. In one embodiment, the low voltage is less than about 3.0 volts.

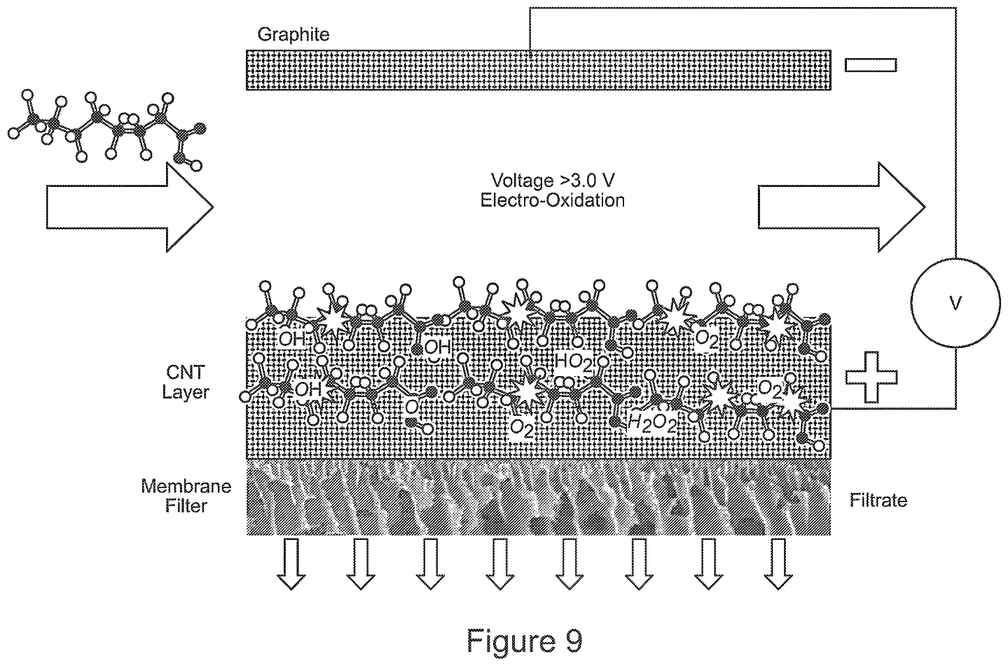

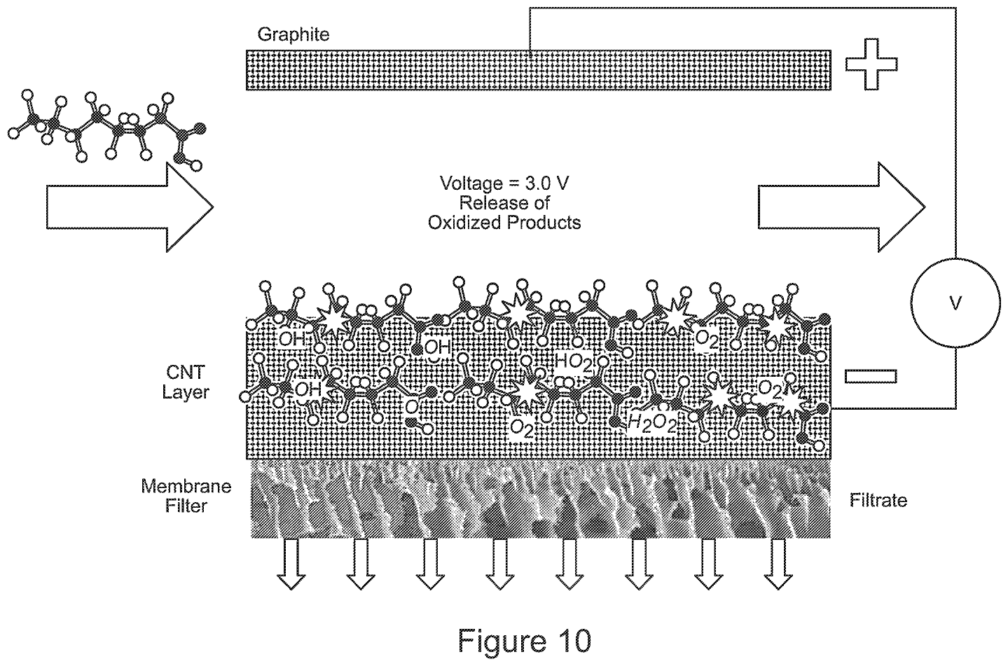

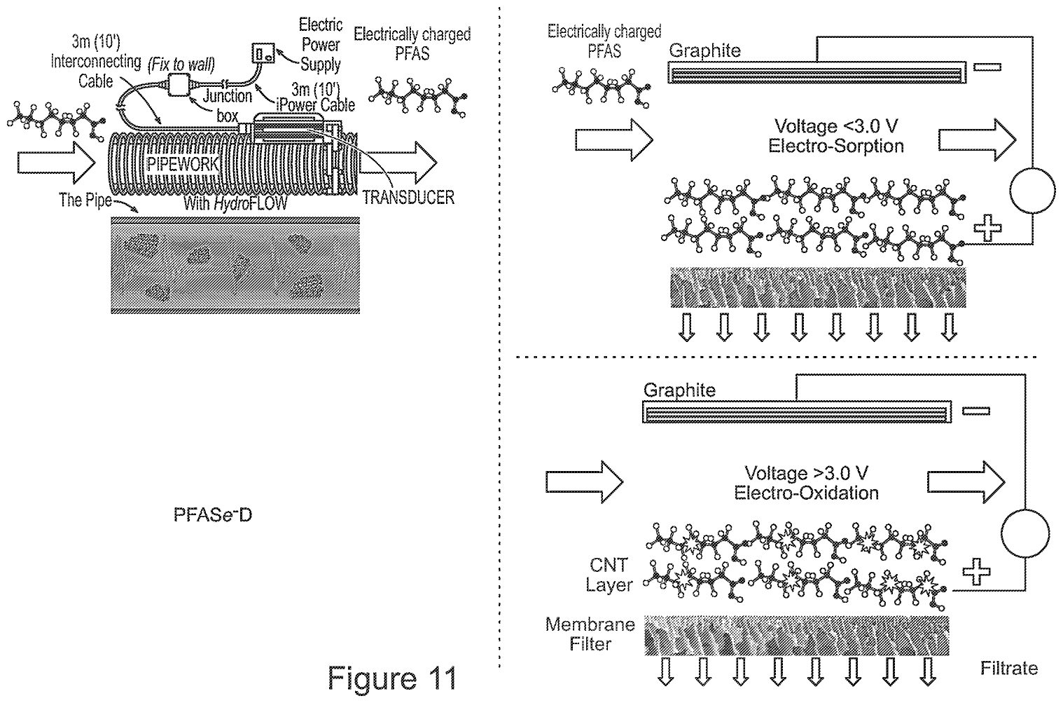

As shown in FIGS. 8 and 9, a second higher voltage is then applied across the membrane. In one embodiment, the higher voltage is more than about 3.0 volts. This higher voltage is configured to degrade the contaminants that are on the membrane. It is contemplated that in one embodiment, the second higher voltage is an amount effective to destroy the contaminants. This may cause some of the particles to become embedded more deeply within the membrane. Thus, as shown in FIG. 10, in one embodiment, the polarity of the electrodes is switched to clean the membrane. In this step, the particles that are embedded move upwardly to become less embedded.

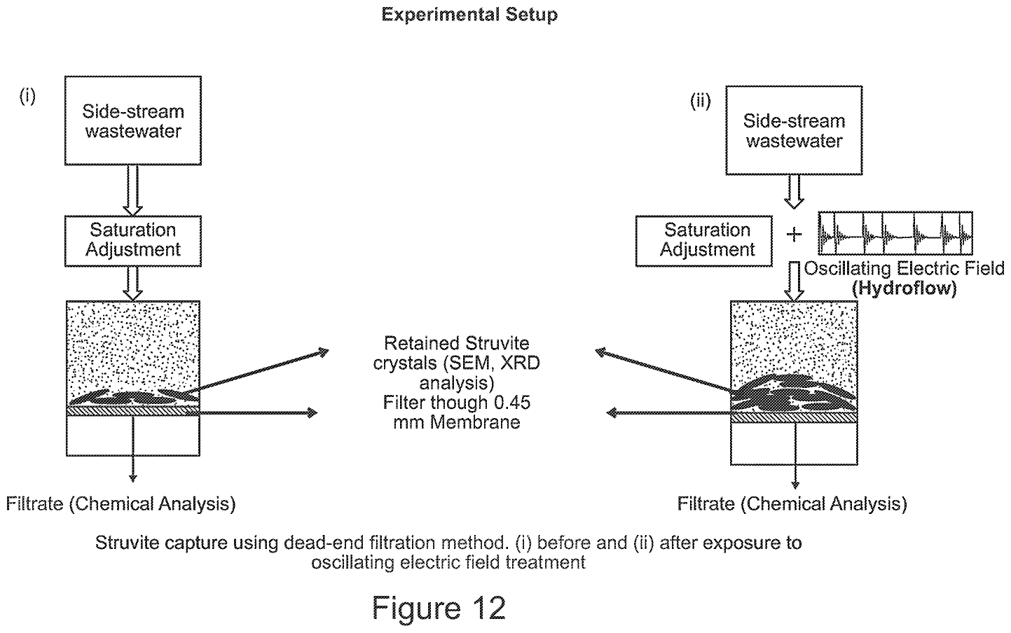

FIG. 11 is an illustration of one embodiment of a water treatment system which includes the EMF device and an electric filtration cell which is configured first for electro-sorption at a voltage of less than 3.0 volts to separate the contaminants on the filtration membrane, and second for electro-oxidation at a higher voltage, greater than 3.0 volts to degrade the contaminants on the filtration membrane.

These above-described embodiments demonstrate a method of removing charged contaminants from a fluid, where the method includes providing a filtration membrane in a fluid passageway, and flowing a fluid through the fluid passageway and through the filtration membrane. The method may further include generating an electromagnetic field within the passageway at a location upstream from the filtration membrane to pretreat the fluid prior to the filtration membrane to enable the charged contaminants to precipitate out of solution. The method also includes generating an electric field across the filtration membrane at an amount effective to separate and degrade the charged contaminants on a first side of the filtration membrane.

In one embodiment, the electric field generated across the filtration membrane is an oscillating electric field. In one embodiment, generating the electric field across the filtration membrane includes generating a first electric field configured to separate the charged contaminants on the first side of the membrane, and generating a second electric field configured to degrade the charged contaminants, where the second electric field is greater than the first electric field. In one embodiment, the first electric field is less than 3.0 volts. In one embodiment, the second electric field is greater than 3.0 volts. Furthermore, in one embodiment, the filtration membrane is configured as a cross flow membrane.

In one embodiment, the charged contaminants separated and degraded on the first side of the filtration membrane include per- and polyfluoroalkyl substances (PFAS). Furthermore, in one embodiment, the fluid includes a water source, such as wastewater. In one embodiment, generating the electric field across the filtration membrane includes electro-oxidation. In one embodiment, generating the electric field across the filtration membrane includes electro-sorption oxidation.

The inventors recognized that there is a growing phosphorous crisis. Notably, phosphorous use is expected to grow by 7.9% by 2025. It is produced via mining and is often used to produce fertilizers. However, there is a risk of running out of phosphorous rock and there is also environmental pollution caused by the excess phosphorous that builds up in the wastewater. Thus, there are multiple incentives to being able to recover nutrients, such as phosphorous, from wastewater. For example, in one embodiment, it is contemplated that carbon dioxide (CO₂) emission reduction via energy conservation and chemical use reduction is an added benefit of removing phosphorous from wastewater. In one embodiment, methods and systems are provided for removing any phosphorous from any phosphorous-rich wastewater, including but not limited to waste slurries, dairy wastewater (i.e. washwater), and other fluid and solid waste/manure applications. In one embodiment, methods and systems are provided for removing any nutrient from a fluid that is rich in that particular nutrient.

The inventors recognized that the current chemical and biological approaches to removing phosphorous are time consuming and thus costly. The inventors also recognized that conventional phosphorous removal methods are less scalable, and are often complex and expensive. The inventors further recognized that phosphorous scarcity and the high cost of fertilizers also dictate a need for phosphorous recovery. Finally, the inventors recognized that phosphorous recovery can provide environmental and economic benefits.

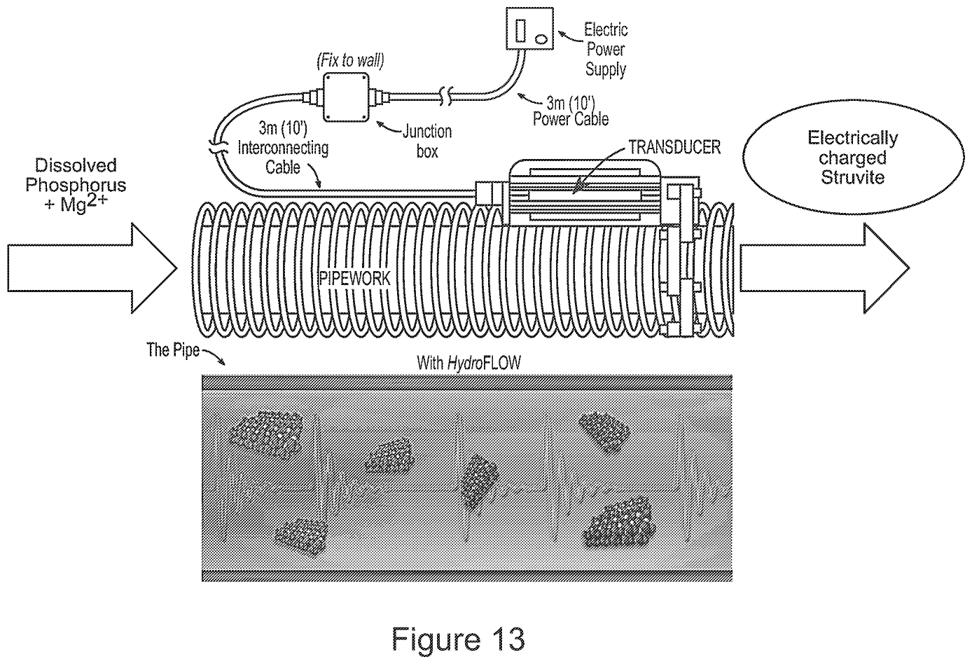

Thus, the inventors recognized the need to investigate the effect of the oscillating field on struvite precipitation (i.e. phosphorous removal) in a side-stream wastewater. Furthermore, the inventors recognized a need to delineate the mechanisms of struvite precipitation in the presence of an oscillating electric field. FIG. 12 is a schematic which illustrates one embodiment of an experimental setup used to accomplish these objectives. In particular, struvite was captured using a dead-end filtration method. On the left is a representation of the experiment before exposure to an oscillating electric field, and on the right is a representation of the experiment after exposure to an oscillating electric field. As set forth in more detail below, the inventors made adjustments to the saturation levels to optimize the results.

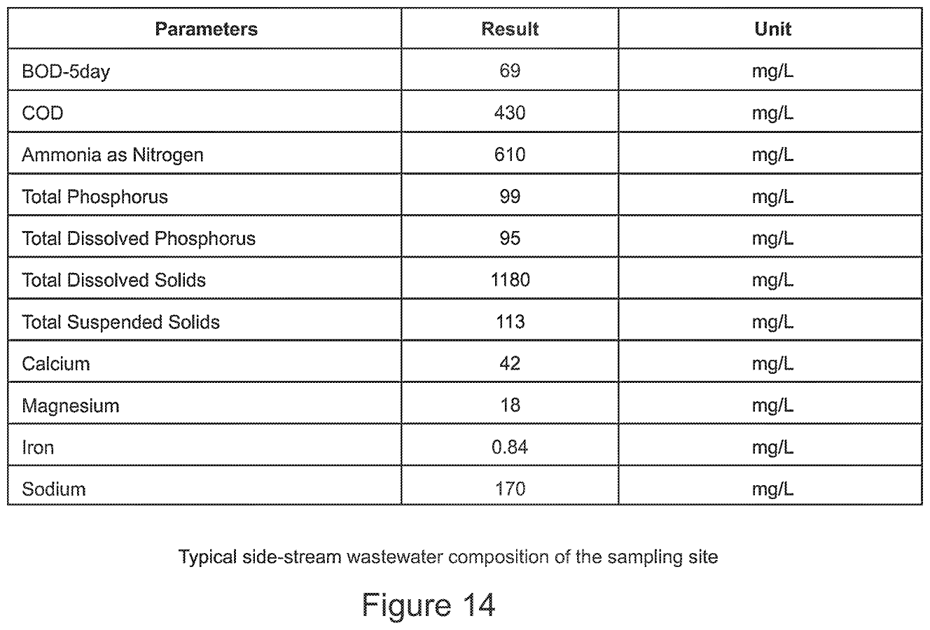

FIG. 13 is a schematic which illustrates one type of EMF device which may be used in the water treatment system obtained from HydroFlow. Details regarding the HydroFlow EMF device may be found in U.S. Pat. No. 9,140,412 which is incorporated by reference in its entirety. In summary, the device applies a radio frequency electromagnetic signal. As shown in FIG. 13, the EMF device includes a core element of magnetically permeable material extending around the conduit/passageway. As shown, seed ions, including dissolved phosphorous and Mg²⁺ may be added to the fluid to produce electrically charged struvite. In one embodiment, the input is 120 V AC signal at 60 Hz frequency, the output is 1-3 V AC signal at 150 KHz frequency. In one embodiment, one or more EMF devices produces a decaying signal with a pulsing current to create a time varying magnetic field. In one embodiment, the time varying magnetic field creates an induced electric field inside of the conduit/passageway.

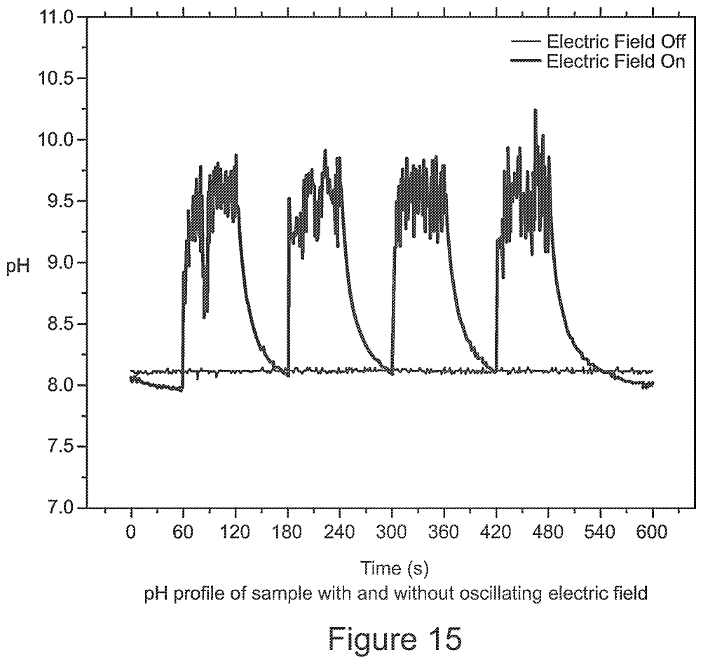

The inventors recognized that a combination of an oscillating electric field and water composition synergistically acts to enhance the homogeneous nucleation of struvite resulting in enhanced phosphorous recovery. As outlined below, the inventors have conducted various experiments using the above-described setup, making various adjustments to the electrohydrodynamic parameters to fine tune the process to make the phosphorous recovery in the form of crystals more efficient. For example, the sample type used was side-stream wastewater with varying relative supersaturation rations (0.48, 0.76, 1.01, 1.29, 1.62, and 2.59). The electric field frequency was +/−150 kHz (constant) and the voltage was 1-3V. The experimental condition was batch-static condition, batch-mixing condition or completely-mixed flow reactor (CMFR), and the inventors monitored the following parameters: pH, temperature, nucleation induction time, mass of recovered solids, crystal morphology, and wastewater composition. FIG. 14 is a schematic which illustrates typical side-stream wastewater composition of the sampling site.

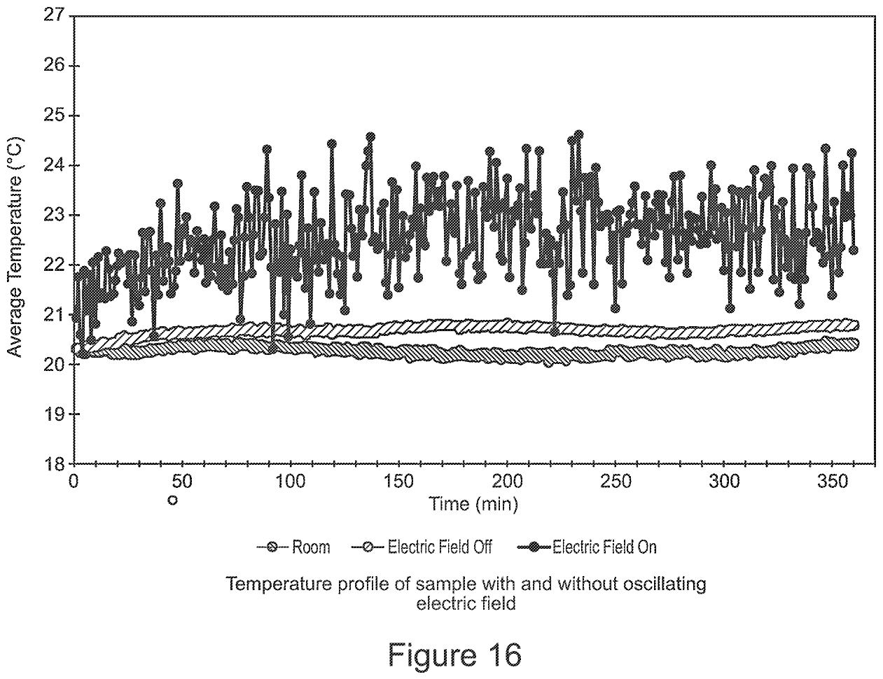

FIGS. 15-21 illustrate the experimental results uncovered by the inventors. In particular, FIG. 15 illustrates the effects of the oscillating electric field on the solution pH. As shown in FIG. 15, the pH profile of a fluid sample without an oscillating electric field is relatively constant at just over 8.0. In contrast, the pH profile of a fluid sample with an oscillating electric field fluctuates is higher and ranges between about 8.0 and 10.0. The pH fluctuation presumably follows the Faradaic reaction mechanism. Faradaic reactions are electromechanical reactions where ions are transferred into or out of electrolyte solutions, thus causing oxidation or reduction. An electrical double layer (EDL) forms in the presence of an AC field at the surface of the electrodes. Literature review suggests an irreversible change in pH, however, as shown in FIG. 15, in the above-described system, there is a reversible change in the pH of the fluid sample.

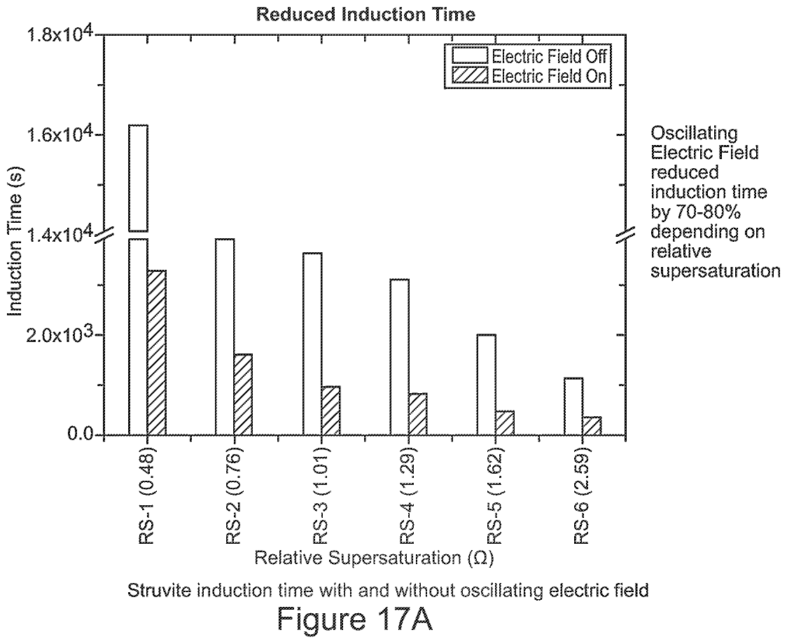

FIG. 16 illustrates the effects of the oscillating electric field on the solution temperature. As shown in FIG. 16, the temperature of a fluid sample without an oscillating electric field is relatively constant at about 21° C. In contrast, the temperature of a fluid sample with an oscillating field is higher and ranges between about 21° C. and 25° C. It is contemplated that the oscillating electric field increases the vibration among the molecules resulting in escalated collision among the charged particles. The temperature of the fluid sample increases due to higher collisions among the charged particles.

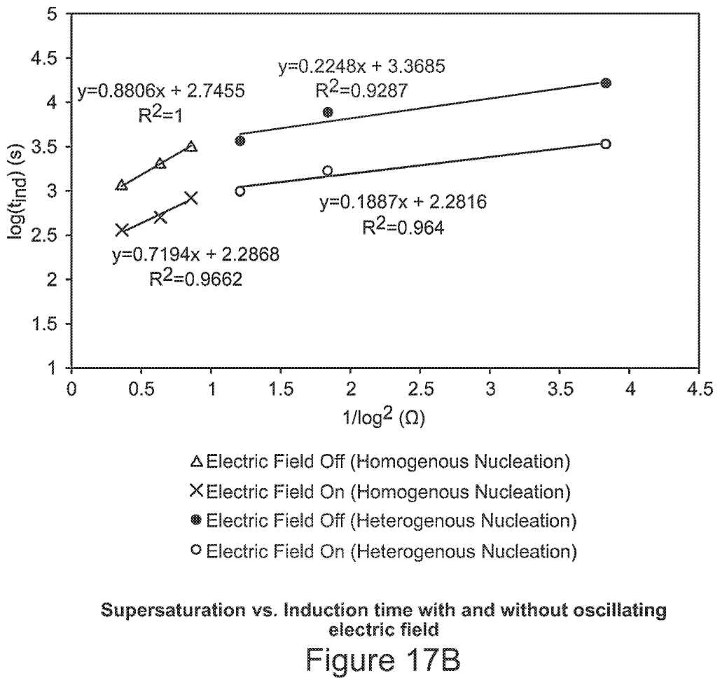

FIGS. 17A and 17B illustrate the effects of the oscillating electric field on struvite induction time. As shown, the inventors conducted experiments varying the relative supersaturation of the fluid. Regardless of relative supersaturation level, the struvite induction time was reduced with an oscillating electric field, in comparison to without an oscillating electric field. In particular, the oscillating electric field reduced induction time by at least 70-80% depending on the relative supersaturation.

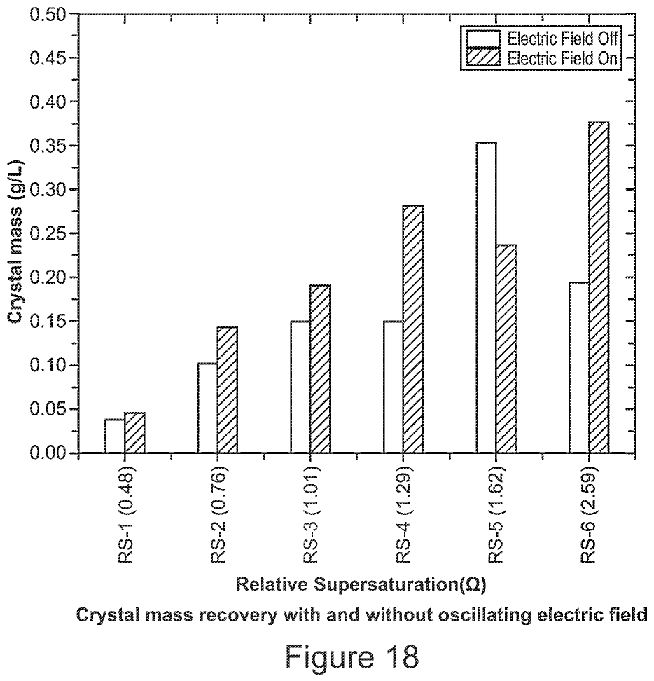

FIG. 18 illustrates the effects of the oscillating electric field on solids recovery. In general, the crystal mass recovery was greater with an oscillating electric field in comparison to crystal mass recovery without an oscillating electric field. As shown, the inventors conducted experiments varying the relative supersaturation of the fluid. It is contemplated that the higher solids recovery is attributed to flocculation and settling. On average, about 30%-90% more crystals were recovered depending on different relative saturation levels.

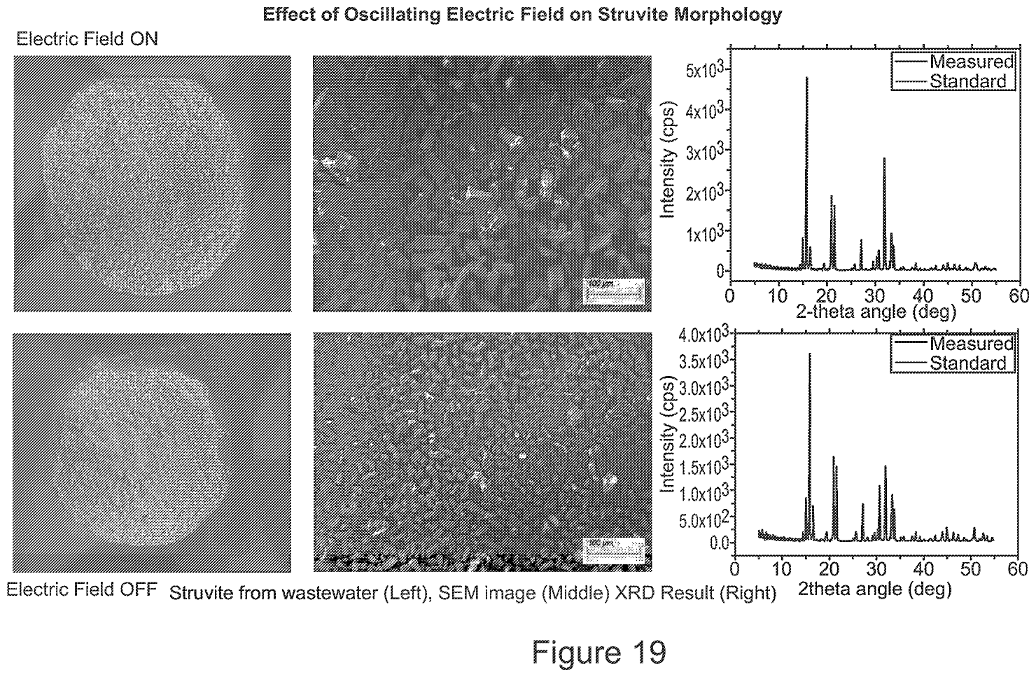

FIG. 19 illustrates the effects of the oscillating electric field on struvite morphology. As shown, the inventors recognized that the struvite produced with an oscillating electric field was larger than the struvite produced without an oscillating electric field.

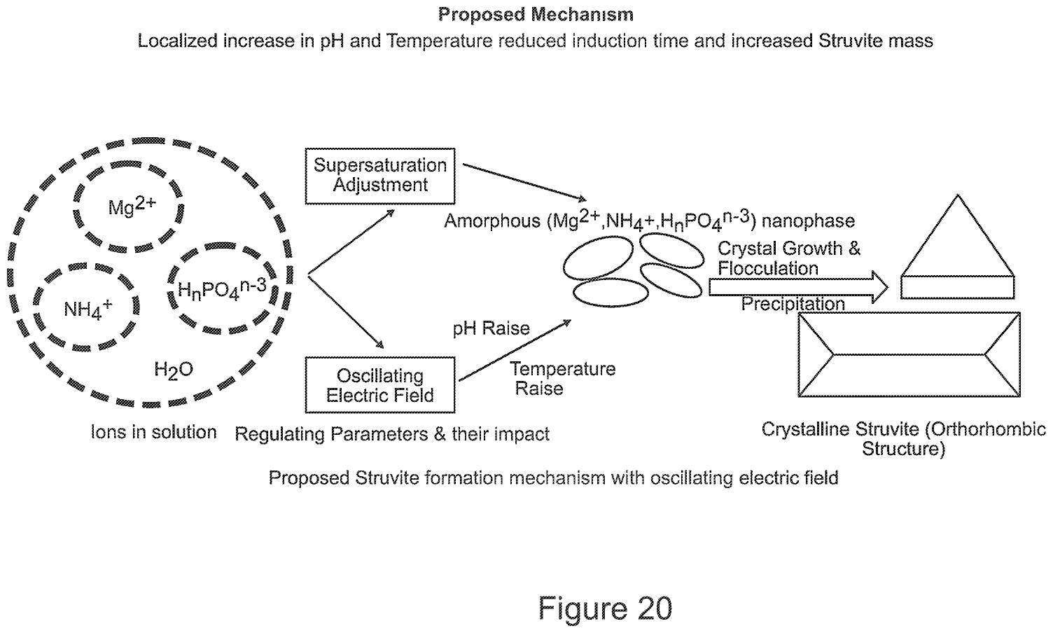

FIG. 20 illustrates a schematic of one embodiment of the proposed mechanism used to form struvite with an oscillating electric field. As shown, the inventors recognized that the oscillating electric field caused both a localized increase in pH and temperature, which in turn reduced the induction time and also increased struvite mass. The inventors also recognized that adjusting the relative supersaturation may also reduce induction time and also increase struvite mass. The inventors recognized that by adjusting these parameters, one can optimize the system by both increasing the size of the crystalline struvite, and also decreasing the amount of time required to form the struvite.

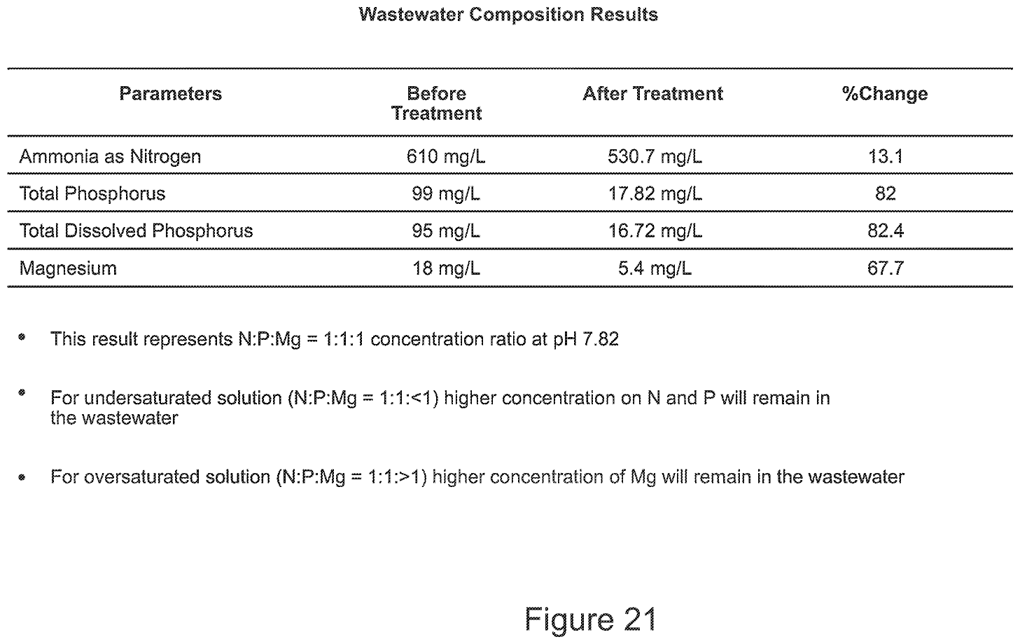

FIG. 21 illustrates wastewater composition results according to one embodiment. These above-described experiments demonstrate that supersaturation, pH, and temperature have an effect on struvite generation under the influence of an oscillating electric field. Furthermore, in one embodiment, the inclusion of an oscillating electric field reduces crystal induction time by about 70%-80% and increases the mass of crystal by about 30%-90% through pH and temperature increases.

These above-described embodiments demonstrate a method of removing charged nutrients from a fluid, where the method includes providing a filtration membrane in a fluid passageway, flowing a fluid through the fluid passageway and through the filtration membrane, and generating an electromagnetic field within the passageway at a location upstream from the filtration membrane to pretreat the fluid prior to the filtration membrane to enable the charged nutrients to precipitate out of solution. The method also includes generating an oscillating electric field across the filtration membrane at an amount effective to separate the charged nutrients on a first side of the filtration membrane, and where the relative supersaturation of the fluid is at least 1. In one embodiment, the relative supersaturation of the fluid is between about 1.0 and about 3.0.

In one embodiment, the pH level of the fluid increases when the oscillating electric field is generated. In one embodiment, the pH level of the fluid decreases when the oscillating electric field is off.

In one embodiment, the temperature of the fluid increases when the oscillating electric field is generated and the temperature of the fluid decreases when the oscillating electric field is off.

In one embodiment, the induction time to separate the charged nutrients on the first side of the membrane is at least 70% less with the oscillating electric field in comparison to without an oscillating electric field. In another embodiment the induction time to separate the charged nutrients on the first side of the membrane is at least 80% less with the oscillating electric field.

In one embodiment, the charged nutrients separated on the first side of the filtration membrane include phosphorous. In another embodiment, the charged nutrients on the first side of the filtration membrane include phosphorous and nitrogen, in the form of struvite. The above described electric filtration cell helps to dewater and concentration struvite suspensions.

In one embodiment, a portable unit is configured to be deployed to a wastewater system to separate charged nutrients from the wastewater system, and the portable unit is configured to perform the above recited method. In one particular embodiment, the portable unit is sized to fit on a towable trailer, and the portable unit is configured to selectively be coupled to a wastewater system to separate charged nutrients from the wastewater system. In one embodiment, the portable unit includes one or more of the components featured in the schematic shown in FIG. 2.

### Further Data and Examples

As outlined below, additional testing was conducted to further verify the advantages of the above-described embodiments. It has been established that the pilot system can consistently recover up to 85% phosphorus from the side-stream wastewater. Table 1 below illustrates the consistency of phosphorus recovery with Hydroflow treatment. It should be appreciated that in this patent application the term “Hydroflow treatment” may be used to reference generating an electromagnetic field with an electromagnetic field device (EMF device) as described above. As shown in Table 1, on an average 82.7±3.59%, 84.06±2.4% total and total dissolved phosphorus were recovered with Hydroflow treatment. Table 2 below illustrates that there was about 12% of ammonium-nitrogen recovery.

TABLE 1
Total phosphorus and total dissolved phosphorus removal chart

| | Total Phosphorus Removal | | Total Dissolved Phosphorus Removal | |
|---|---|---|---|---|
| | Efficiency (%) | | Efficiency (%) | |
| | w/Hydroflow | w/o Hydroflow | w/Hydroflow | w/o Hydroflow |
| Test 1 | 82 | 85.33 | 84.63 | 88.07 |
| Test 2 | 75.25 | 74.06 | 78.61 | 76.26 |
| Test 3 | 82.85 | 81.42 | 82.35 | 83.82 |
| Test 4 | 84.29 | 84.29 | 86.18 | 87.06 |
| Test 5 | 80 | 82.91 | 83.97 | 77.73 |
| Test 6 | 88.18 | 84.73 | 86.67 | 83.33 |
| Test 7 | 85.1 | 84.55 | 85 | 82.62 |
| Test 8 | 83.94 | 81.52 | 85.05 | 82.68 |
| Mean | 82.7 | 82.35 | 84.06 | 82.69 |
| SD | 3.59 | 3.42 | 2.40 | 3.8 |

TABLE 2
NH₄—N removal efficiency

NH₄—N Removal Efficiency (%)

| | w/Hydroflow | w/o Hydroflow |
|---|---|---|
| Test 1 | 31.72 | 5.2 |
| Test 2 | 8.07 | 9.68 |
| Test 3 | 30.39 | 33.33 |
| Test 4 | 33.33 | 3.92 |
| Test 5 | 9.8 | 3.92 |
| Test 6 | 25.42 | 18.64 |
| Mean | 23.12 | 12.45 |
| SD | 10.33 | 10.64 |

Determination of nucleation induction time for ‘Struvite’ crystallization: Different concentrations of Mg²⁺ were added to the side-stream wastewater to achieve different saturation levels in the untreated water. Immediately after the addition of Mg²⁺, struvite crystal nucleation induction time was monitored for these different saturation levels. These different saturation levels are called relative supersaturation and they are calculated using following equations:

$${Mg}^{2 +} + {NH}_{4}^{+} + {PO}_{4}^{3 -} + 6 {H}_{2} O = {MgNH}_{4} {PO}_{4} \cdot 6 {H}_{2} O$$

$$Ion Activity Product ( IAP ) = [ {Mg}^{2 +} ] [ {NH}_{4}^{+} ] [ {PO}_{4}^{3 -} ]$$

$$Relative Supersaturation , Ω = {( \frac{IAP}{{K}_{sp}} )}^{\frac{1}{3}} - 1$$

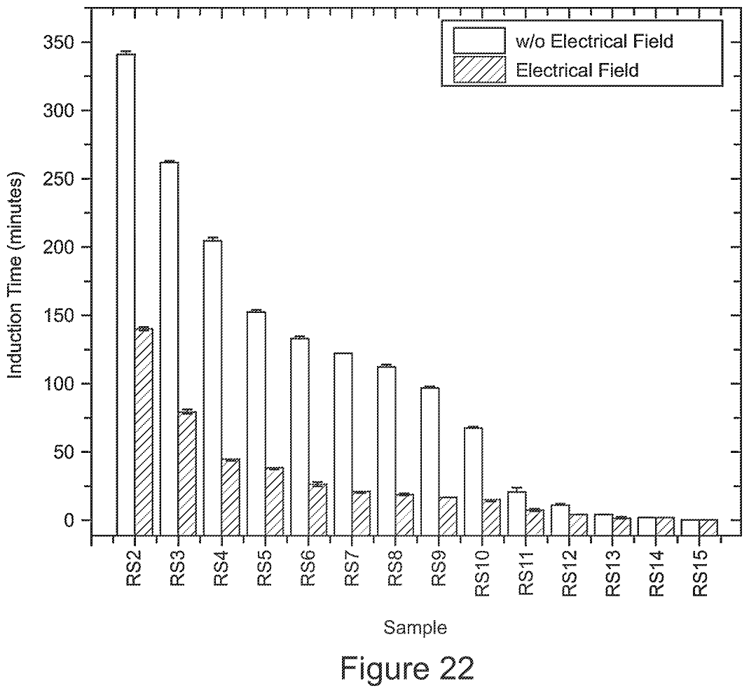

A wide-range of relative supersaturation (RS), including 0.18, 0.4, 0.52, 0.71, 0.83, 0.96, 1.0, 1.1, 1.3, 1.5, 1.81, 2.2, 2.54, 2.81, 3.05 (RS1, RS2, RS3 . . . RS15 respectively), were used in these experiments. FIG. 22 shows the variations in induction times in wastewaters with different RS levels.

FIG. 22 illustrates crystal nucleation time sample with and without the EMF field. More specifically, FIG. 22 shows that the effect of the electromagnetic field (i.e. Hydroflow treatment with an EMF field) on the reaction is higher in suspension with lower relative supersaturation. In one embodiment, an ideal range to recover maximum phosphorus, nitrogen, and magnesium in the form of struvite is RS5-RS8 (i.e. 0.83-1.1). The EMF field reduced the nucleation time by over 80%, which is significant in terms of struvite recovery. In one particular embodiment, the relative supersaturation of the fluid is greater than 1.0 (i.e. R7).

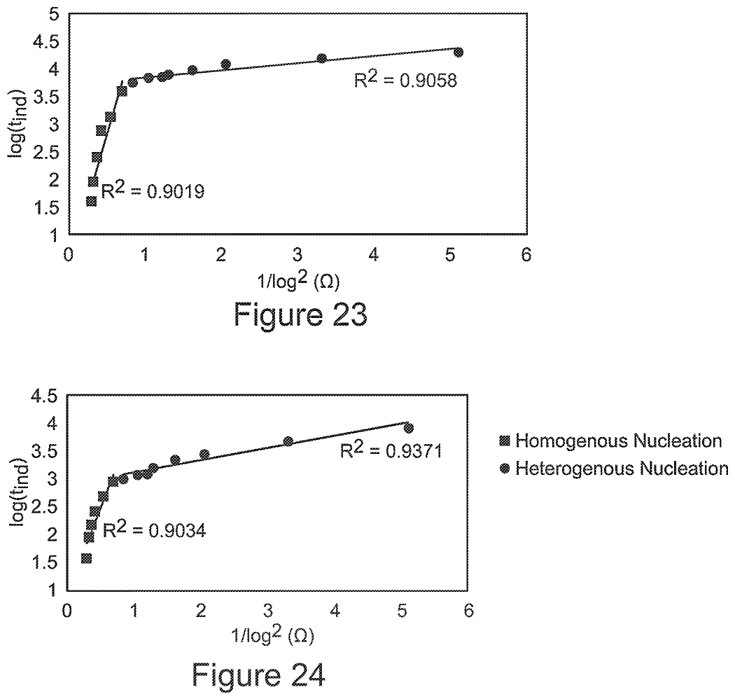

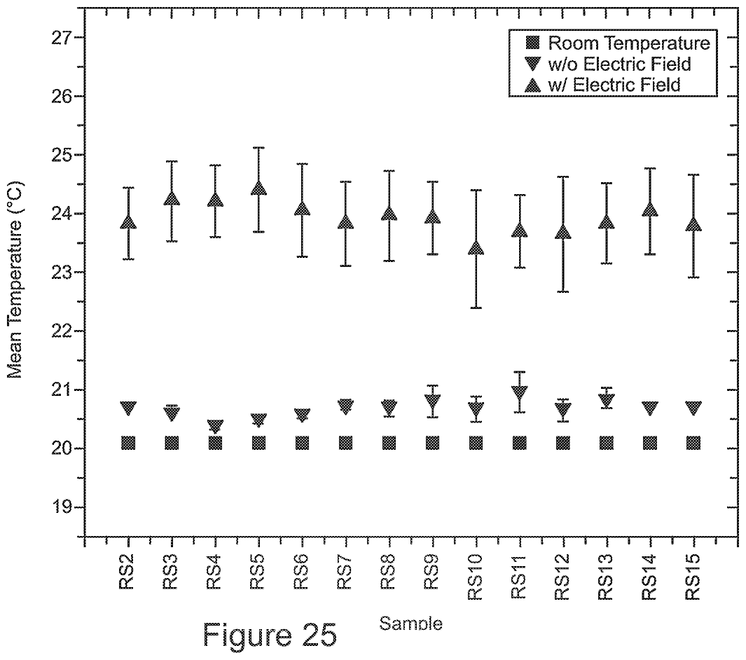

Determination of the mechanism of ‘Struvite’ crystallization: Experimental results demonstrated that there were no significant differences observed between electromagnetic field exposed and control (no field) samples in terms of nucleation mechanism. FIG. 23 illustrates the crystallization mechanism for samples without the EMF exposure (i.e. control) and FIG. 24 illustrates the crystallization mechanism for samples with the EMF exposure. It is apparent from the data that at higher relative supersaturation level, homogeneous nucleation mechanism dominated in both scenarios whereas heterogeneous nucleation was dominated in suspensions with lower relative supersaturation, which essentially determined whether struvite crystals will precipitate in bulk volume due to high concentration of reactants or due to presence of foreign particles or impurities present in the sample. The type of precipitation mechanism determines the quality of struvite recovered in this process. The following mathematical relationship shows the relationship between the induction time and the relative supersaturation:

$$log ( {t}_{ind} ) = \frac{A}{{( log Ω )}^{2}} - B$$

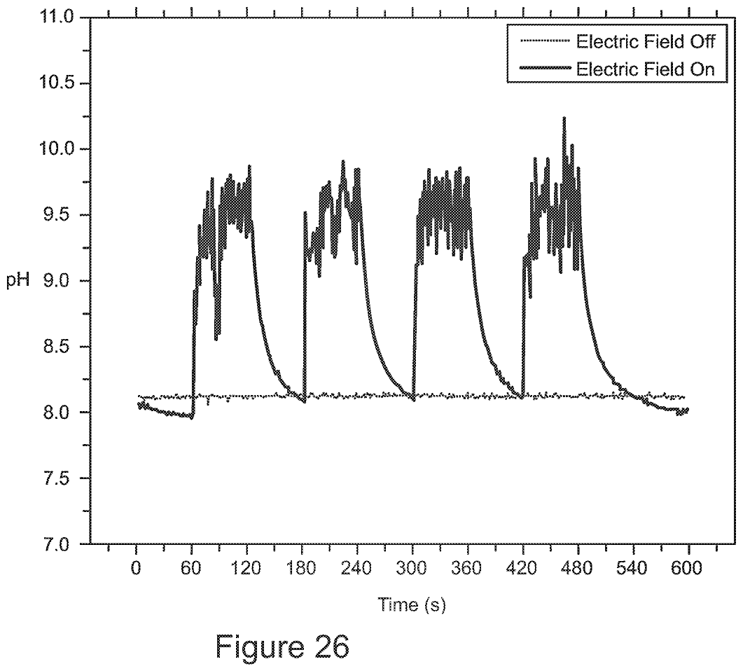

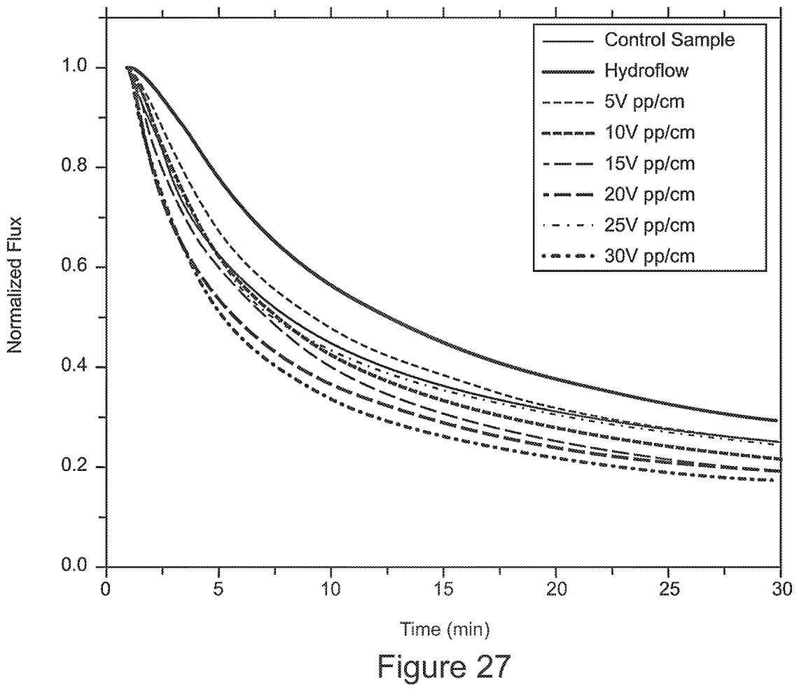

Determining the factor influencing nucleation induction time: During further experimentation, the pH and temperature were monitored due to their significant role in struvite crystallization or scaling processes in conventional processes (no field condition). These same parameters in the presence of the electromagnetic field were also monitored to determine whether they influence the struvite precipitation mechanism in the absence of external pH or temperature adjustments. Results showed that the electromagnetic field indeed affects both the temperature and pH of the reactions as illustrated FIGS. 25 and 26, respectively. In the presence of the field, the temperature of the suspensions was elevated by 3-4° C., which is likely to be significant at the molecular-level interactions between the water molecules and hydrated phosphate, ammonium, and magnesium ions. Similarly, pH dramatically increased by about 1.5 units each time the field was turned, which is a significant finding because the pH of water has become significantly more alkaline which is quite favorable for struvite precipitation.

FIG. 25 illustrates the temperature comparison with and without electromagnetic field exposed samples, and FIG. 26 illustrates the pH comparison with and without electromagnetic field exposed samples. As shown, FIGS. 25 and 26 delineates that the samples exposed to the electromagnetic field have statistically significantly higher (i.e., p>0.05) temperature and pH value during the nucleation process which have accelerated the struvite nucleation and growth, and thereby resulted in significant reduction in crystal nucleation time.

Electric Membrane Filtration (Electrofiltration) system to further capture a fraction of remaining 15% of phosphorus: The system was equipped with pilot-scale membrane filters with carbon electrodes. Also, the system was tested in the presence of an EMF device (i.e. HydroFLOW) and electrofiltration to assess the performance of the system in terms of fouling and phosphorus recovery.

After completing the static bench-scale studies, electrofiltration system tests were initiated to determine the optimal operation parameters. These results were used to evaluate the pilot-scale electrofiltration system. Different combination of electric-field strength, frequency and HydroFLOW® field were used to determine the optimal conditions for efficient struvite precipitation. The struvite recovery was initiated by amending the wastewater samples with Mg²⁺ in the presence of HydroFLOW® field.

Bench-scale membrane filtration parameters are as follows: a.) Struvite recovered supernatant without any intervention (Control sample), b.) Control sample with Hydroflow field; and c.) Test sample exposed to 5, 10, 15, 20, 25 and 30 Vp-p/cm electrical field strength at 1000 Hz frequency.

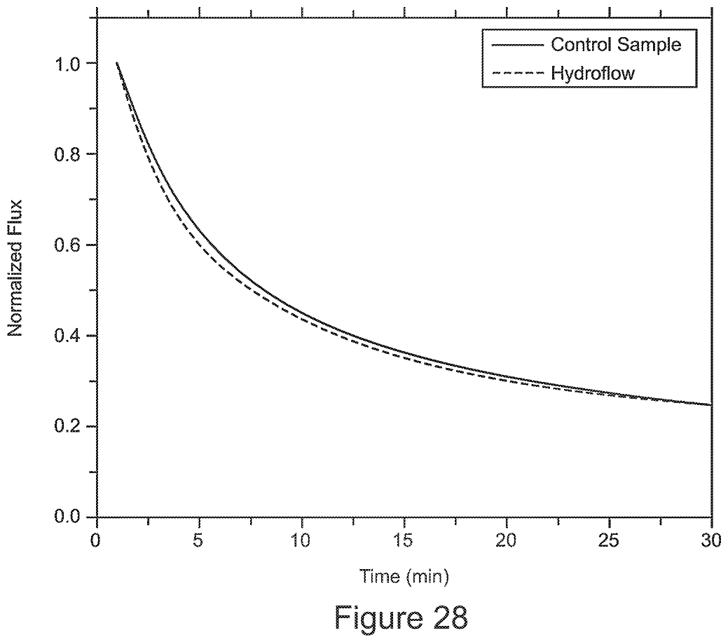

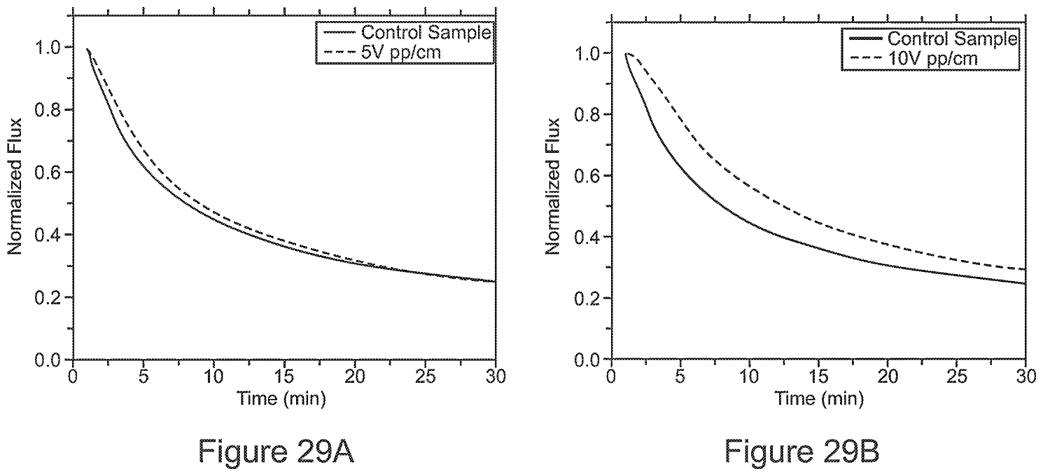

Results of the filtration flux are reported as time vs. Normalized flux (flux divided by maximum flux observed) and the flux has unit of L/m²·h. FIG. 27 illustrates the Bench-scale electrofiltration system in the presence and absence of a range of electric field strengths at a constant frequency of 1000 Hz (combined). FIG. 28 illustrates the control vs. the Hydroflow field alone exposed filtration. The Hydroflow field (10 Vpp/cm and +/−150 kHz) alone showed no effect on filtration flux.

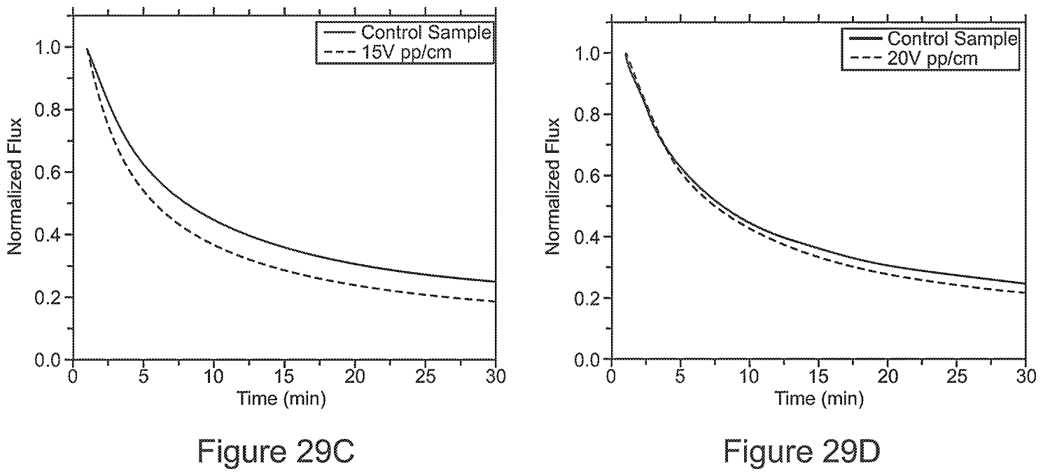

FIGS. 29A-29F illustrate the effect of the electric field strength on filtration flux in an electrofiltration system. The bench-scale study results shown in FIGS. 29A-29F illustrate that 10 Vp-p/cm electric field strength at 1000 Hz frequency are likely to be the optimal electric field parameters for obtaining enhanced flux. These conditions were implemented in the pilot-scale system at Essex facility.

The findings from laboratory research were used to build and test the pilot-scale electrified membrane system. The electrified system was designed to filter 250 gallons of supernatant that has been pre-treated with the electromagnetic field, wherein the 85% phosphorus was already recovered. The supernatant with remaining 15% phosphorus is expected to be treated with the electrified membrane system.

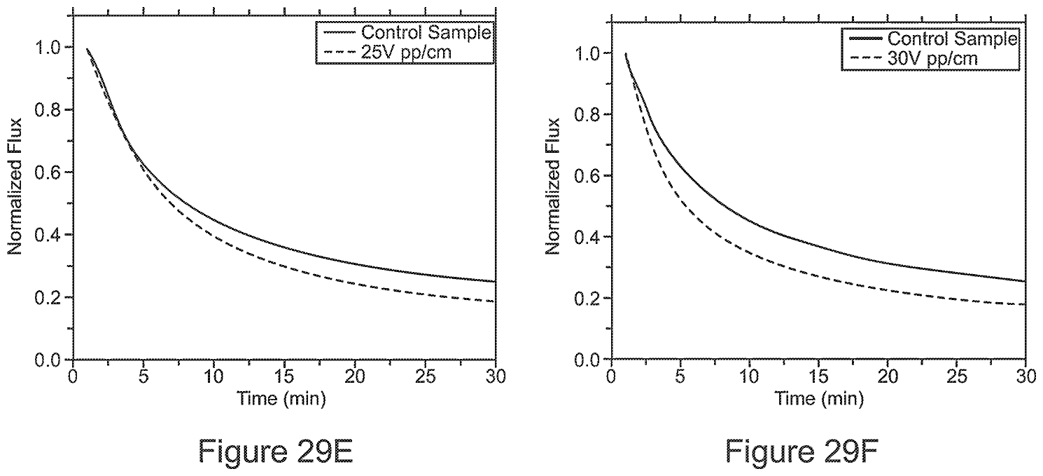

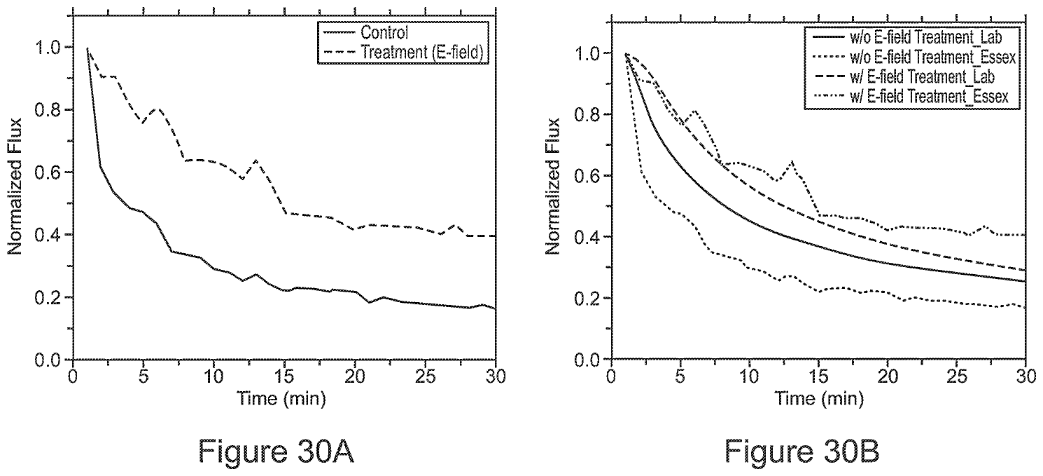

The parameters that were monitored during preliminary tests include (1) the filtration flux in the presence and absence of oscillation electric field (E-field) in the electrified membrane system (see FIGS. 30A and 30B), (2) Phosphorus recovery (Table 3 below), and (3) viability of Escherichia coli as surrogate for coliform disinfection (a new finding).

FIG. 30A shows that filtration flux of a highly concentrated waste stream can be significantly enhanced by 20% in the presence of electric field during the filtration process. This implies electric field increases the filtration efficiency by decreasing membrane fouling. Further research may help to optimize the electric field and membrane operational conditions to mitigate fouling and enhance membrane performance in terms of flux recovery.

FIG. 30B shows the flux performance comparison between lab and pilot-scale electrified membrane system, which implied that both systems performed similarly. Therefore, it reasonable to perform electric and operational parameters optimization studies in the lab, which then can be implemented in the pilot-scale system, and/or a full scale system.

TABLE 3
Phosphorus recovery from remaining 15% of
dissolved phosphorus in supernatant

| | | | Total | | | |
|---|---|---|---|---|---|---|
| | | | Dissolved | | Total | |
| | Ammonia | | Phos- | | Phos- | |
| | as N | % | phorus | % | phorus | % |
| | (mg/L) | Change | (mg/L) | Change | (mg/L) | Change |
| Original | 750 | — | 71 | — | 72 | — |
| Sample | | | | | | |
| Concentrate | 730 | 2.6 | 43 | 39.4 | 43 | 40.3 |
| Filtrate_ | 720 | 4 | 39 | 45.1 | 43 | 40.3 |
| Control | | | | | | |

The above table of results show that the change in phosphorus concentration is insignificant, i.e., none of phosphorus was apparently recovered from the remaining 15% of the phosphorus by the membrane system. This suggests that it is better to switch to ultrafiltration membrane from the microfiltration membrane, which has a nominal pore size of 0.45-μm.

During this further research, the inventors discovered that using the above-described embodiments, the electric field can further disinfect E. coli in the supernatant during the phosphorous recovery process. Preliminary data was obtained, where the original sample contained: 51600 colonies of E. coli/100 mL, and the filtered sample without electric field intervention contained: 3550 colonies/100 mL. Filtered sample with electric field intervention contained: Non-Detect (data confirms this result).

Laboratory research showed that both reactive oxygen species and temperature changes proportionally changed with increasing electric field strength, which in turn affected the E. coli. This is a non-chemical approach to potential disinfection pathogenic bacteria and viruses. Thus, in one embodiment, the above described methods can be employed where the charged contaminants separated and degraded on the first side of the filtration membrane include Escherichia coli.

Although several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto; the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

### REFERENCES

1. Abdel-Aal, E.; Abdel-Ghafar, H.; El Anadouli, B., New findings about nucleation and crystal growth of reverse osmosis desalination scales with and without inhibitor. Crystal Growth & Design 2015, 15 (10), 5133-5137.
2. Alexander, L. F.; Radacsi, N., Application of electric fields for controlling crystallization. CrystEngComm 2019, 21 (34), 5014-5031.
3. An, R.; Massa, K.; Wipf, D. O.; Minerick, A. R., Solution pH change in non-uniform alternating current electric fields at frequencies above the electrode charging frequency. Biomicrofluidics 2014, 8 (6), 064126.
4. Bhuiyan, M. I. H.; Mavinic, D.; Beckie, R., Nucleation and growth kinetics of struvite in a fluidized bed reactor. Journal of Crystal Growth 2008, 310 (6), 1187-1194.
5. Healthline, How Your Body Uses Phosphorus.
6. Heraldy, E.; Rahmawati, F.; Putra, D. In Application of quantitative XRD on the precipitation of struvite from Brine Water, IOP Conference Series: Materials Science and Engineering, IOP Publishing: 2017; p 012015.
7. Le Corre, K. S.; Valsami-Jones, E.; Hobbs, P.; Parsons, S. A., Phosphorus recovery from wastewater by struvite crystallization: A review. Critical Reviews in Environmental Science and Technology 2009, 39 (6), 433-477.
8. Medline.
9. Meneses, N.; Jaeger, H.; Knorr, D., pH-changes during pulsed electric field treatments-Numerical simulation and insitu impact on polyphenoloxidase inactivation. Innovative Food Science & Emerging Technologies 2011, 12 (4), 499-504.
10. Patel, J. K.; Parshina-Kottas, Y., Miles of Algae Covering Lake Erie. 2017.
11. Saulis, G.; Lapė, R.; Pranevičiūtė, R.; Mickevičius, D., Changes of the solution pH due to exposure by high-voltage electric pulses. Bioelectrochemistry 2005, 67 (1), 101-108.
12. Sharp, R.; Vadiveloo, E.; Fergen, R.; Moncholi, M.; Pitt, P.; Wankmuller, D.; Latimer, R., A theoretical and practical evaluation of struvite control and recovery. Water environment research 2013, 85 (8), 675-686.
13. USGS, Phosphate Rock Statistics and Information.

1. A method of removing charged contaminants from a fluid, the method comprising:
providing a filtration membrane in a fluid passageway;
flowing a fluid through the fluid passageway and through the filtration membrane;
generating an electromagnetic field within the passageway at a location upstream from the filtration membrane to pretreat the fluid prior to the filtration membrane to enable the charged contaminants to precipitate out of solution; and
generating an electric field across the filtration membrane at an amount effective to separate and degrade the charged contaminants on a first side of the filtration membrane.

2. The method of claim 1, wherein the electric field generated across the filtration membrane is an oscillating electric field.

3. The method of claim 1, wherein generating the electric field across the filtration membrane includes:
generating a first electric field configured to separate the charged contaminants on the first side of the membrane; and
generating a second electric field configured to degrade the charged contaminants, wherein the second electric field is greater than the first electric field.

4. The method of claim 3, wherein the first electric field is less than 3.0 volts.

5. The method of claim 4, wherein the second electric field is greater than 3.0 volts.

6. The method of claim 1, wherein the filtration membrane is configured as a cross flow membrane.

7. The method of claim 1, wherein the charged contaminants separated and degraded on the first side of the filtration membrane include per- and polyfluoroalkyl substances (PFAS).

8. The method of claim 1, wherein the charged contaminants separated and degraded on the first side of the filtration membrane include Escherichia coli.

9. The method of claim 1, wherein the fluid includes a water source.

10. The method of claim 1, wherein generating the electric field across the filtration membrane includes electro-oxidation.

11. The method of claim 1, wherein generating the electric field across the filtration membrane includes electro-sorption oxidation.

12. A portable unit, configured to be deployed to a wastewater system to separate charged contaminants from the wastewater system, wherein the portable unit is configured to perform the method recited in claim 1.

13. (canceled)

14. A method of removing charged nutrients from a fluid, the method comprising:
providing a filtration membrane in a fluid passageway;
flowing a fluid through the fluid passageway and through the filtration membrane;
generating an electromagnetic field within the passageway at a location upstream from the filtration membrane to pretreat the fluid prior to the filtration membrane to enable the charged nutrients to precipitate out of solution;
generating an oscillating electric field across the filtration membrane at an amount effective to separate the charged nutrients on a first side of the filtration membrane; and
wherein the relative supersaturation of the fluid is at least 1.

15. The method recited in claim 14, wherein the relative supersaturation of the fluid is between about 1.0 and 3.0.

16. The method recited in claim 14, wherein the pH level of the fluid increases when the oscillating electric field is generated.

17. The method of claim 16, wherein the pH level of the fluid decreases when the oscillating electric field is off.

18. The method of claim 14, wherein the temperature of the fluid increases when the oscillating electric field is generated.

19. The method of claim 18, wherein the temperature of the fluid decreases when the oscillating electric field is off.

20. The method of claim 14, wherein the induction time to separate the charged nutrients on the first side of the membrane is at least 70% less with the oscillating electric field.

21. The method of claim 14, wherein the charged nutrients separated on the first side of the filtration membrane include phosphorous.

22-23. (canceled)
